(19) United States
(12) Patent Application Publication
(10) Pub. No.: US 2009/0162616 A1
(43) Pub. Date: Jun. 25, 2009

(54) MESOSTRUCTURED MATERIALS WITH CONTROLLED ORIENTATIONAL ORDERING

(76) Inventors: Bradley F. Chmelka, Goleta, CA (US); Douglas Wildemuth, Cincinnati, OH (US); George L. Athens, Midland, MI (US); Jordi Nolla, Catalunya (ES); Justin Jahnke, Goleta, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 12/335,225

(22) Filed: Dec. 15, 2008

Related U.S. Application Data
(63) Continuation-in-part of application No. 11/735,252, filed on Apr. 13, 2007.
(60) Provisional application No. 61/013,919, filed on Dec. 14, 2007.
(60) Provisional application No. 60/792,050, filed on Apr. 13, 2006.

(51) Int. Cl. B32B 3/30; B32B 5/02; B29C 59/00

(52) U.S. Cl. 428/167; 428/364; 264/293

(57) ABSTRACT

Methods of controlling orientational ordering in self-assembled materials are described. These methods include controlling the nucleation rate and growth of block-copolymer-templated silica domains to yield macroscopically aligned mesostructured materials, and forming patterned mesostructured films or monoliths with control over the direction of alignment of a hexagonally-packed, block-copolymer-directed mesostructure across macroscopic lengths scales are described. Self-assembled materials with controlled orientational ordering are described, including those that contain a surfactant or block-copolymer species, and materials that include an organic (e.g., resin) or inorganic (e.g., silica or titania) network-forming component.

### CROSS-REFERENCE TO RELATED APPLICATIONS

This application claims priority from U.S. provisional application Ser. No. 61/013,919 filed on Dec. 14, 2007, incorporated herein by reference in its entirety. This application is also a continuation-in-part of U.S. patent application Ser. No. 11/735,252 filed on Apr. 13, 2007, incorporated herein by reference in its entirety, which claims priority from U.S. provisional application No. 60/792,050, filed on Apr. 13, 2006, incorporated herein by reference in its entirety.

### STATEMENT REGARDING FEDERALLY SPONSORED RESEARCH OR DEVELOPMENT

This invention was made with Government support under Grant No. DMR-02-33728 awarded by the National Science Foundation. The Government has certain rights in this invention.

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to preparing mesostructured materials, and more particularly to controlling the nucleation rate and growth of block-copolymer-templated silica domains to yield highly macroscopically aligned mesostructured materials.

2. Background Discussion

Surfactant-templated mesoporous materials have been a field of interest since their discovery in the early 1990s. In the past decade, extensive research has focused on the development of mesostructured materials from a wide range of surfactants with applications as catalyst supports, membranes, and as hosts for optical devices. Emphasis has been placed on syntheses of diverse compositions (e.g., inorganic oxides), phases (e.g., cubic, hexagonal, and lamellar), and morphologies (e.g., powders, films, fibers, and monoliths). Recently, there has been substantial interest in producing and controlling macroscopic orientational ordering in such mesostructured materials. Photovoltaic cells, light emitting diodes (LEDs), waveguides, fuel cells, etc. all may benefit from the anisotropic properties of orientationally ordered channels and/or guest molecules in aligned mesostructured composite materials. In addition, aligned mesoporous materials may be useful for promoting anisotropic growth of single crystals.

Mesoscale materials have also received substantial attention for their potential to become an inexpensive and efficient new technology in the fields of sensors, membranes, catalysis, and optics. Many potential applications require or would benefit from macroscopic alignment of anisotropic mesostructures with uniform arrays of mesochannels that are accessible to different guest species.

Furthermore, incorporation of photo- (or synonymously, optically) responsive molecules into aligned mesostructured composite materials has potential technological benefits in anisotropic absorption or emission in optical devices, as well as providing evidence of the anisotropic nature of the oriented mesochannels.

### BRIEF SUMMARY OF THE INVENTION

In prior work described in U.S. Patent Application Publication No. US-2007-0248760-A1 (Mesostructured Inorganic Materials Prepared with Controllable Orientational Ordering), the entire disclosure of which is incorporated herein by reference, we showed that mesostructured inorganic-organic materials, in the form of patterned films, monoliths, and fibers, can be prepared with controllable orientational ordering over macroscopic length scales. The materials were synthesized by controlling solvent removal rates across material interfaces, in conjunction with the rates of surfactant self-assembly and inorganic cross-linking and surface interactions. In that work, we described a method for controlling the rates and directions of solvent removal from a heterogeneous material synthesis mixture that allows the nucleation and directional alignment of self-assembling mesostructures to be controlled during synthesis. The aligned mesostructured inorganic-organic materials and mesoporous inorganic or carbon materials can be prepared in the form of patterned films, monoliths, and fibers with controllable orientational ordering. Such materials possess anisotropic structural, mechanical, optical, reaction, or transport properties that can be exploited for numerous applications in opto-electronics, separations, fuel cells, catalysis, MEMS/microfluidics, for example.

It has now been found that, with careful control over the rates and directions of the solvent and co-solvent removal, one can control the nucleation rate and growth of block-copolymer-templated silica and titania domains to yield highly macroscopically aligned mesostructured materials.

Accordingly, an aspect of the present invention described herein is control over solvent and cosolvent removal, one embodiment of which is the use of soft-lithographic patterning materials with specific solubility properties for the volatile species in the block copolymer sol-gel precursor solution. The PDMS stamping protocol allows for this control, as well as for the simultaneous patterning of the mesostructured composite material, establishing where domain nucleation occurs, and the direction(s) that they grow, thereby directing the ultimate alignment of a resulting hexagonal mesostructure. Product films result with macroscopically anisotropic properties that can be exploited in membrane and optical applications. One example is the incorporation of photo-responsive supra- or macromolecular guest species, the resulting nanocomposite materials of which may exhibit anisotropic optical properties.

Another aspect of this invention is to develop and control macroscopic orientational ordering of new patterned mesostructured silica or titania films. The hexagonal and lamellar phases of block-copolymer/silica mesostructured materials are of particular interest, due to their intrinsic anisotropy, compared to the cubic phase. Alignment of the mesostructured domains perpendicular to the substrate is of interest because of the importance of creating mesochannel contacts between the substrate and the external surfaces of films in applications for sensors, membranes, and opto-electronic devices. Other orientations of the mesostructured domains parallel to the substrate also have applications in anisotropic optical materials, fuel cell devices, or field effect transistors. Materials with the combination of a high degree of mesoscopic ordering, with controllable alignments, are expected to yield anisotropic properties with significant technological advantages for polarized absorption or emission of light, oriented crystal growth, semipermeable membranes, catalysts, or device assembly.

Another aspect of the invention is a method of forming patterned mesostructured silica or titania films with control over the direction of alignment of a block-copolymer-directed hexagonal mesostructure across macroscopic lengths scales. By way of example, and not of limitation, this can be achieved by using a patterned poly(dimethylsiloxane) soft-lithography stamp to control the rates and directions of the solvent removal, e.g. water, and/or cosolvents, such as ethanol or tetrahydrofuran, from the block-copolymer/silica (or titania) sol-gel solution. In addition to sol-gel composition and block-copolymer architecture, key variables are solution acidity, solvent selection(s), the solvent concentrations in the PDMS stamp, PDMS surfaces in contact with the precursor solution, and surrounding atmosphere, and temperature. These variables collectively influence the relative rates of solvent diffusion and/or evaporation, block-copolymer self-assembly, domain growth, and silica cross-linking. By controlling the direction(s) of solvent and cosolvent fluxes out of the drying film (patterned or otherwise), control can be exerted over the interfaces where the self-assembling domains first nucleate and the direction that they grow.

Vertical, longitudinal, or lateral orientational ordering of patterned, hexagonally mesostructured silica-P132 films have been demonstrated. In particular, mesostructures with high degrees of alignment perpendicular to the substrate can be produced with radially integrated (100) diffraction peak widths as narrow as 3 degrees FWHM observed. The high degree of alignment was also shown to be present over large macroscopic regions of the entire film area (2.25 cm²). Cross-sectional TEM imaging corroborated the vertical alignment of the mesochannels and established that they form a continuous contact between the film surface and the substrate. X-ray diffraction studies have shown that in some regions of the patterned films, vertically and laterally aligned mesostructures may coexist, though it is not yet clear how such mixed domains form.

The principles by which the direction and flux of solvent species out of the patterned block-copolymer/sol-gel films were controlled during synthesis was extended to produce hexagonal mesostructures orientationally ordered parallel to the substrate with their cylinders aligned along the longitudinal axis of the microchannels. Radial integration of the (100) diffraction peaks also shows high degrees of alignment with widths of 10 degrees FWHM. The results indicate that the formation of longitudinally aligned and hexagonally mesostructured silica-P123 is favored when thick (˜7 mm) PDMS stamps, saturated with ethanol, are used to pattern and direct the nucleation of self-assembling domains from ethanolic solutions. It has been shown that the longitudinal alignment is extended over macroscopic length scales.

The anisotropic properties of orientationally ordered mesostructured silica/block-copolymer films are expected to enable new applications in separations, catalysis, and optoelectronics. Removal of the structure-directing block copolymer species by calcination or solvent extraction results in porous films that can be functionalized to introduce desirable interior surface properties for selective adsorption or permeability. Alternatively, functional guest molecules can be introduced during syntheses of orientationally ordered mesostructured host films, provided that the guest species can be solubilized and co-assembled during the patterning process. For example, photo-responsive guest molecules were included in one-pot syntheses to co-assemble and thereby incorporate the guest-molecules (including semiconducting polymers and J-aggregated porphyrin dyes in patterned, hexagonally mesostructured and vertically aligned silica-P123 films. It has also been shown that inclusion of guest molecules by backfilling hydrophobically functionalized mesopores, following removal of the block-copolymer species, is feasible. The alignment of photo-responsive guest molecules in orientationally ordered mesostructured hosts matrices is expected to induce anisotropic optical properties, with potential device applications in light-emitting diodes, photovoltaics, and optoelectronics.

Another aspect of the invention is a method of controlling orientational ordering in self-assembled materials. One embodiment of this aspect comprises controlling solvent removal from a precursor solution.

Another embodiment comprises preparing a patterned stamp/mold for use as a mold for directing the patterning of the self-assembled material as it forms from a precursor solution; producing the precursor solution; drying the precursor solution in the presence of the patterned stamp/mold; and controlling the rate and direction of solvent/co-solvent species removal from the drying precursor solution.

In another embodiment, a said self-assembled material contains a surfactant or block-copolymer species. In a further embodiment, the said self-assembled material includes a network-forming component. In still another embodiment, the network-forming component comprises an organic or inorganic component. In one embodiment, the organic component comprises a resin. In one embodiment, the inorganic comprises silica or titania.

In a still further embodiment a said self-assembled material contains a functional guest species. In one embodiment, the guest species comprises a photo-responsive molecule or nanoparticle. In another embodiment, the orientational ordering occurs for hexagonal, lamellar, cubic or other phases, including crystalline phases.

In one mode, the orientational ordering occurs in a patterned film. In another mode, the orientational ordering occurs in a monolith or fiber.

In another embodiment, removal of solvent/co-solvent species is controlled with respect to the rate of removal. In a further embodiment, removal of solvent/co-solvent is controlled with respect to the direction of removal. In a still further embodiment, the surfactant or block-copolymer species are chosen, along with solvent/co-solvent and stamp/mold surface properties, so that said self-assembled material nucleates and grows at a surface. In another embodiment, removal of solvent/co-solvent is combined with the use of other externally applied fields, such as an electric field, a magnetic field, light, or fluid flow. In still another embodiment, solvent/co-solvent removal or externally applied fields are varied transiently.

Another aspect of the invention is the formation of self-assembled materials formed according to one or more of the methods described above.

Another aspect of the invention is an assembled structure comprising a substrate and a mesostructured material supported by the substrate; said mesostructured material having a perpendicular axis, a longitudinal axis, a lateral axis, or a radial axis, relative to the substrate; said mesostructured material comprising a plurality of mesochannels orientationally ordered along the same axial direction in relation to a said axis of the substrate.

A further aspect of the invention is an assembled structure comprising a substrate, a microchannel supported by the substrate where the microchannel has a perpendicular axis, a longitudinal axis, and a lateral axis, wherein the microchannel comprises a mesostructure and wherein the mesostructure comprises a plurality of mesochannels orientationally ordered along the same axial direction in relation to a said axis of the microchannel. In one embodiment, the substrate comprises a metalized or oxide substrate. In further embodiments, the substrate comprises titanium or aluminum. In various modes, the orientational ordering occurs for hexagonal, lamellar, cubic or other phases, including crystalline phases.

Another aspect of the invention is an orientationally ordered mesostructure that exhibits anisotropic properties. In various embodiments, the anisotropic properties are selected from the group consisting of anisotropic ion-transport, diffusion, reaction, photoluminescent properties, light-emission and light-absorption.

Another aspect of the invention is an orientationally ordered mesostructure that includes a photo-responsive molecule or nanoparticle.

Another aspect of the invention is a mesostructure that exhibits orientational order>100 nm from a surface and >100 μm in one or more dimensions.

Another aspect of the invention is a mesostructure that contains organic, inorganic, or a mixture of such species in a covalently bonded network. In one embodiment, the covalently bonded network contains species that aid the incorporation and/or influence the location or interactions of guest species within said mesostructure.

Another aspect of the invention is a self-assembled structure in the form of a film. In one embodiment, the film is a patterned film.

Another aspect of the invention is a self-assembled structure in the form of a monolith.

Another aspect of the invention is a self-assembled structure in the form of a fiber.

In one embodiment, the mesostructure comprises a hexagonal mesostructure that is orientationally ordered predominantly perpendicular to the microchannel.

In another embodiment, the mesostructure comprises a hexagonal mesostructure that is orientationally ordered predominantly lateral to the microchannel.

In a further embodiment, the mesostructure comprises a hexagonal mesostructure that is orientationally ordered predominantly longitudinal to the microchannel.

In another embodiment, the mesostructure contains guest species that are also orientationally ordered.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1: Schematic diagrams showing cross-sectional views of aligned hexagonal mesostructured films formed on hydrophilic (FIG. 1A) or hydrophobic (FIG. 1B) surfaces viewed end-on in the plane of the substrate, and showing an aligned mesostructured film with cylinders oriented perpendicular to the substrate (FIG. 1C).

FIG. 2: (FIG. 2A) Schematic diagram depicting the method of applying a patterned PDMS stamp onto a hydrolyzed block-copolymer/silica sol-gel precursor solution using a metalized (titanium or aluminum) substrate on a Kapton® support; (FIG. 2B) Schematic diagram depicting absorption of solvent and cosolvent species (ethanol, water) into the PDMS and equilibration within a closed environmental chamber kept at a constant relative humidity (RH) by use of an appropriate saturated salt solution; (FIG. 2C) Schematic diagram depicting the patterned block-copolymer-templated silica film on a metalized Kapton® support after removal of the PDMS stamp, respectively.

FIG. 3: Schematic diagram depicting a small region of a patterned block-copolymer-templated mesostructured silica film formed by soft lithographic micromolding using a PDMS stamp. The three axes associated with possible alignment directions of the hexagonal mesostructure are labeled and assigned relative to the plane of the substrate and the direction of the microchannels.

FIG. 4: Schematic diagrams depicting (FIG. 4A) the experimental setup for transmission-mode SAXS diffraction measurements and (FIG. 4B-D) the relative angles of the incident X-ray beam relative to different orientations of the mesostructure with the hypothetical resulting SAXS diffraction patterns for (FIG. 4B) vertically, (FIG. 4C) laterally, and (FIG. 4D) longitudinally aligned hexagonal silica mesostructures.

FIG. 5: Schematic diagrams depicting (FIG. 5A) the experimental setup for GI-SAXS diffraction measurements and (FIG. 5B-5C) the relative angles of the incident X-ray beam relative to different orientations of the mesostructure with the hypothetical resulting SAXS diffraction pattern for (FIG. 5B) vertically, (FIG. 5C) laterally, and (FIG. 5D) longitudinally aligned hexagonal silica mesostructures.

FIG. 6: (FIG. 6A) SEM image of a single ˜1 μm high by 7 μm wide microchannel of the hexagonally mesostructured P123/silica film formed by the patterned PDMS stamp after FIB milling of a 125-nm-thick cross-section; (FIG. 6B) Cross-sectional FIB TEM image of the microchannel shown in FIG. 6A, taken parallel to the substrate, showing the highly aligned hexagonal mesostructure oriented perpendicular to the substrate; (FIG. 6C) TEM image of a similar sample except formed on a titanium-metalized Kapton® substrate; (FIG. 6D) Transmission-mode SAXS diffraction pattern of a patterned and mesostructured P123-silica film on aluminum-metalized Kapton® substrate, synthesized as described in the text; (FIG. 6E) 2D radial integration of the SAXS pattern in FIG. 6D acquired in transmission-mode (see FIG. 4A).

FIG. 7: Pourbaix diagrams of (FIG. 7A) aluminum and (FIG. 7B) titanium showing the various oxidation states present in the metal, which are dependent upon the pH and potential of the aqueous solution at 25° C.

FIG. 8: Schematic diagram depicting a route of solvent removal into a non-saturated PDMS stamp and initial nucleation of the hexagonal mesostructured silica when allowed to dry in the patterned microchannels.

FIG. 9: (FIG. 9A) Transmission-mode SAXS diffraction pattern of a patterned and mesostructured P123-silica film on titanium-metalized Kapton® substrate, synthesized as described in the text; (FIG. 9B) 2D radial integration of the SAXS pattern acquired in transmission-mode (see FIG. 4A).

FIG. 10A and FIG. 10B: Schematic diagrams showing two types of stamps used in forming mesostructures.

FIG. 11: (FIG. 11A) Schematic diagram showing the different locations with respect to the film area where the 2D SAXS patterns were acquired along the 15 mm longitudinal axes of an ensemble (1 mm2 X-ray beam spot) of 1 μm×7 μm microchannels of a PDMS-patterned hexagonally mesostructured silica-P123 film in which the microchannel ends were closed; (FIG. 11B) 2D SAXS patterns taken from locations i-v depicted in (FIG. 11A); (FIG. 11C) 2D radial integration showing the high degree of alignment of SAXS pattern iii.

FIG. 12: (FIG. 12A) Schematic diagram showing the different locations with respect to the film area where 2D SAXS patterns were acquired; (FIG. 12B) 2D SAXS patterns taken from locations i-vi depicted in FIG. 12A; (FIG. 12C) 2D radial integration showing the high degree of alignment of SAXS pattern i.

FIG. 13: 2D SAXS patterns of mesostructured silica-P123 films with 1 μm high×7 μm wide×˜12 mm long microchannels formed from an ethanol/water solution patterned using a PDMS stamp under fixed relative humidities of (a) 97%, (b) 84%, (c) 69%, (d) 54%, and (e) 33% at room temperature.

FIG. 14: 2D SAXS patterns of mesostructured silica-P123 films where the saturation fraction of the ethanol in the vapor phase of the environmental chamber was initialized to fractions of (a) 0%, (b) 25%, (c) 50%, and (d) 75%.

FIG. 15: (FIG. 15A) Transmission-mode 2D SAXS pattern of a hexagonally mesostructured silica-P123 film with 1 μm high×7 μm wide×15 mm long microchannels; (FIG. 15B) 2D radial integration of FIG. 15A; (FIG. 15C) Transmission-mode 2D SAXS pattern of the same sample in FIG. 15A, 15B after calcination at 500° C.; (FIG. 15D) 2D radial integration of FIG. 15C.

FIG. 16: (FIG. 16A) Schematic diagram illustrating the orientations of the macroscopic film and its microchannels relative to the X-ray beam in transmission-mode diffraction studies; (FIG. 16B) Transmission-mode 2D SAXS pattern of mesostructured silica-P123 films with 1 μm high×7 μm wide×15 mm long microchannels formed from an ethanol/water solution patterned using a PDMS stamp under fixed relative humidity of 97% showing no apparent mesostructural order present; (FIG. 16C) Schematic diagram illustrating the tilted orientation of the same sample and microchannels relative to the X-ray beam in diffraction studies with the sample rotated 30 degrees about the lateral axis to show the (100) reflections from a laterally aligned hexagonal mesostructure; (FIG. 16D) 2D SAXS diffraction pattern of the same sample as in FIG. 16B showing the presence of the (100) diffraction spots from lateral alignment of the mesostructure; (FIG. 16E) Cross-sectional FIB TEM image of the same sample taken parallel to the substrate, showing the highly aligned hexagonal mesostructure oriented parallel to the substrate, laterally across the 7 μm width of the microchannel.

FIG. 17: (FIG. 17A) Transmission-mode 2D SAXS diffraction pattern showing the presence of a hexagonal mesostructured and highly perpendicularly aligned PDMS-patterned (1 μm high×7 μm wide×15 mm long microchannels) silica-P123 film; (FIG. 17B) 2D SAXS pattern of approximately the same location on the same sample (at the center of the film) obtained by tilting 30 degrees along the lateral axis of the film, showing the appearance of (100) diffraction peaks, which indicate the presence of co-existing laterally aligned hexagonal mesostructured regions.

FIG. 18: (FIG. 18A) 2D SAXS pattern of a hexagonally mesostructured silica-P123 film formed using a patterned PDMS stamp with 1 μm high×7 μm wide×7 mm long microchannels that was saturated in ethanol; (FIG. 18B) 2D radial integration of the SAXS pattern in FIG. 18A showing a high degree of alignment (˜10 degrees FWHM); (FIG. 18C) FIB TEM micrograph of the same sample showing a cross-sectional image of the center portion of a single microchannel on a aluminum/Kapton® substrate, approximately 3 mm from the sol-gel precursor solution/air interface, confirming the high degree of longitudinal alignment indicated by (FIG. 18A, B); (FIG. 18D) TEM image of a similar sample, except formed on a titanium-coated Kapton® substrate, with the FIB cut made along the longitudinal axis of the microchannel to show the longitudinal alignment down the microchannel axis.

FIG. 19: (FIG. 19A) Schematic diagram showing the different locations where the 2D SAXS patterns were acquired along the 1 μm high×7 μm wide×7 mm long microchannels of a PDMS-patterned, hexagonally mesostructured silica-P123 film; (FIG. 19B) 2D SAXS patterns taken from locations i-iv, as indicated in FIG. 19A; (FIG. 19C) 2D radial integration showing the high degree of alignment of SAXS pattern ii.

FIG. 20: Schematic diagram illustrating solvent evaporation from open microchannel ends exposed to a controlled atmosphere used to synthesize patterned hexagonally mesostructured silica-P123 films.

FIG. 21: Schematic diagram depicting a cross-section of the apparatus used in the attempt to form a 3D monolith of a well ordered and aligned hexagonal silica/P123 mesostructure, showing the dimensions of the cavity inside the Teflon® mold.

FIG. 22: Polarized optical micrographs of patterned P123-silica mesostructured films formed from a precursor sol containing 1 wt % TPPS4 porphyrin dye (a) with an aligned mesostructure, with the vertical axis of the film parallel to one polarizer; (b) with an aligned mesostructure, with the vertical axis of the film 45 degrees to both polarizers; (c) without mesostructural alignment, with the vertical axis of the film parallel to one polarizer; (d) without mesostructural alignment, with the vertical axis of the film 45 degrees to both polarizers. Arrows represent the direction of polarization of the incident light.

FIG. 23: Fluorescence microscope images of patterned mesostructured P123-silica films (approximately 600 μm thickness) formed by incorporation of semiconducting poly(9,9-dioctylfluorine) (PF8) polymer species from a THF-based silica sol with approximately (FIG. 23A) 1.5 wt % PF8 and (FIG. 23B) 0.08 wt % PF8. Insets: Transmission-mode SAXS diffraction patterns from approximately the same part of the film areas as the respective photos; (FIG. 23C) Normalized photoluminescence spectra of the two films with excitation at 380 nm.

FIG. 24: (FIG. 24A, 24B) Azimuthal integration of SAXS diffraction patterns of mesostructured SBA-16 powders: (FIG. 24A) As-synthesized F127-silca and (FIG. 24B) after removal of the F127 species by solvent extraction (insets: 2D diffraction patterns); (FIG. 24C, 24D) Solid-state single-pulse 1D ²⁹Si MAS NMR spectra of (FIG. 24C) the same solvent-extracted silica powder in (FIG. 24B) and (FIG. 24D) after functionalization with n-butyltrichlorosilane. The ²⁹Si NMR measurements were conducted at room temperature under MAS conditions at 10 kHz.

FIG. 25: (FIG. 25A) Schematic diagram of the conjugated octaphenylene oligomers incorporated into the hydrophobically-functionalized cubic mesoporous silica powder; (FIG. 25B) Normalized photoluminescence spectra of the conjugated oligomers dissolved in anhydrous toluene 0.025 mg/mL (solid line, at 325 nm) and when incorporated into hydrophobically-functionalized cubic mesoporous silica powder after brief washing for 5 min in toluene (dashed line, at 325 nm); (FIG. 25C) Photoluminescence spectra of conjugated oligomers incorporated into hydrophobically-functionalized cubic mesoporous silica powder before washing (solid line, excitation at 275 nm) and after washing (dashed line, excitation at 275 nm) for 5 min in toluene.

FIG. 26: (FIG. 26A) Schematic diagram showing the general configuration for conducting transmission-mode SAXS measurements of patterned mesostructured films; (FIG. 26B-26D) Specific SAXS-sample configurations with respect to three different orientationally ordered hexagonally mesostructured titania-Brij®-56 films, accompanied by validating experimental results for (FIG. 26B) vertically, (FIG. 26C) laterally, and (FIG. 26D) longitudinally aligned mesostructures, respectively.

FIG. 27: (left) Schematic diagram of two microchannels on a micropatterned substrate, with representative dimensions used in the preparation of the orientationally ordered mesostructured titania; (right) a focused-ion-beam TEM image of a cross-section of a vertically aligned, hexagonal mesostructured titania-Brij®-56 film showing the high extent of vertical alignment of the cylinders.

FIG. 28: Fluorescence confocal micrograph of a micropatterned mesostructured titania-Brij®-56 film with 0.12 wt % MEH-PPV conjugated polymer guest species.

### DETAILED DESCRIPTION OF THE PREFERRED EMBODIMENTS OF THE INVENTION

### Introduction

If one is to make an efficient material, and ultimately a device that takes advantage of the intrinsically anisotropic properties of a mesophase host matrix, the mesostructure should possess a high degree of alignment, as well as include guest molecules that adopt aligned configurations within the host structures. Furthermore, the film should be patternable for fabrication and integration into devices. These properties are provided by block-copolymer-templated silica composites, which can yield aligned, hexagonal inorganic-organic mesostructures that can serve as anisotropic host matrices for guest molecules. For example, for photo-responsive guests, anisotropic optical properties are expected, provided that the guest species are orientationally ordered in the aligned channels of a mesostructured host. Furthermore, it is desirable to control the specific orientation of any resulting alignment (relative to the substrate or pattern features), which would impart significant versatility for a wide range of different applications.

Self-assembled materials rely on amphiphilic surfactants (ionic, or in the present case, non-ionic triblock copolymers), which form micelles and eventually liquid-crystal-like phases, as the surfactant concentration increases due to solvent evaporation. In the case of amphiphilic triblock copolymers, the surfactant is composed of at least two types of different monomer units that self-assemble to minimize interactions with one another during micellization or mesostructure formation. The phase obtained depends on the composition (e.g., type of block copolymer, water, cosolvent, inorganic precursor, and guest/solute contents) and conditions (e.g., temperature and pressure) of the mixture, according to the balance of entropic and enthalpic interactions among the different species present. These interactions, and resulting phase behaviors, have been well studied for different non-ionic block copolymer water-alcohol mixtures under equilibrium conditions.

Block-copolymer/silica mesostructured materials, however, are much more complicated multi-component, non-equilibrium, and heterogeneous systems. Nevertheless, their phase behaviors both in precursor solutions and in the final products can be estimated and manipulated using guidance from equilibrium phase diagrams and from general predictive methods. Ternary block-copolymer-water-cosolvent (e.g. ethanol, butanol, etc.) phase diagrams can be used to guide the selection of the compositions required for the formation of specific phases. This includes the mesostructures of different bulk macroscopic morphologies, such as films, fibers, monoliths and powders, where non-equilibrium drying, domain nucleation and growth, and silica cross-linking processes can exist.

Mesostructured composite materials have been prepared as patterned films that permit independent control of structural ordering on multiple, discrete length scales, including those relevant to micro- and opto-electronic devices. This has been achieved by using soft lithography, which addresses similar length scales as conventional photolithography methods. However, by exploiting favorable thermodynamics of self-assembly from solution, soft lithographic processing may be much less expensive. In soft lithography, a patterned mesostructured film can be prepared directly by use of a pre-patterned mold (herein referred to as a “stamp” or “micromold”) that directs the shape and form of the self-assembling mesostructured (2-50 nm) composite on a substrate over microscopic (1-10 μm) and macroscopic (>100 μm) length scales.

Without control over the drying and thus nucleation processes, an unaligned mesostructured material typically forms with self-assembled mesophase domains oriented isotropically. In addition, the pH of the solution relative to the isoelectric point of the network-forming inorganic species (e.g., silica: pH 1.7-2.5) controls the relative rates of silica hydrolysis and condensation, along with electrostatic interactions with the block copolymer species. Yet, by selecting processing conditions that allow the rates or directions of solvent and cosolvent (e.g., water, ethanol, or THF) removal to be controlled, nucleation and alignment of the mesostructured domains can also be controlled. Other methods for drying have also yielded highly aligned mesostructures in monoliths and in capillaries. In dip-coating, the initial nucleation has been reported to occur at the triple interface between the block-copolymer/sol-gel solution, the surrounding vapor, and the substrate. It is the combined thermodynamic and kinetic properties of the self-assembling components and their interactions with the surfaces across which the solvent and cosolvent species are removed, that account for the nucleation, growth, and alignment of the first and all subsequent hexagonal domains.

### Example

### Hexagonal Mesostructured Films

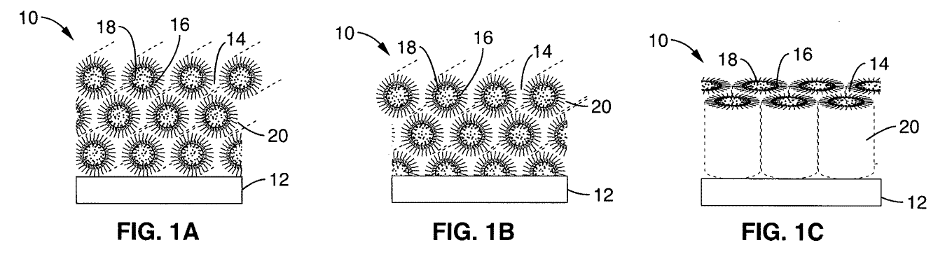

FIG. 1A through FIG. 1C show schematic cross-sectional views of aligned hexagonal mesostructured films 10 according to the present invention supported by a substrate 12. For the specific examples presented, hydrophilic-hydrophobic structure-directing species were used, in which the hydrophilic regions of the resulting mesostructured materials were continuous and hydrophobic regions formed cylinders that were hexagonally arrayed. FIG. 1A illustrates such films formed on hydrophilic surfaces and FIGS. 1B, 1C illustrate two possibilities for films formed on hydrophobic surfaces, both structures being viewed end-on in the plane of the substrate. The regions 14 represent hydrophilic silica, the regions 16 represent the hydrophilic components of the block copolymer, and the regions 18 represent the hydrophobic components of the block copolymer. FIG. 1C illustrates an aligned mesostructured film according to the invention with cylinders 20 oriented perpendicular (i.e., vertical) to the substrate.

When the substrate is hydrophilic, the hexagonal mesostructure tends to align parallel to the substrate with hydrophilic components at the substrate interface, as shown in FIG. 1A. By comparison, when the substrate is hydrophobic, lower energy interfaces result when there is more contact between the hydrophobic surfactant components and substrate. This may yield hexagonal mesostructures aligned parallel to the substrate (e.g., micelle hemi-cylinders), shown in FIG. 1B or with the cylinders normal to the surface, shown in FIG. 1C, depending on the respective and relative interactions of the hydrophobic and hydrophilic surfactant components with the substrate.

Thus, controlling only the relative hydrophilicity/hydrophobicity of the substrate is generally not enough to induce the hexagonal mesostructure to adopt an orientation perpendicular to the substrate. If perpendicular alignment is to occur, the substrate should be energetically favorable, and the nucleation rate should be slow enough to control the location of nucleation (as opposed to simultaneous nucleation throughout the microchannels, which would lead to an isotropic distribution of mesostructured domain orientations).

By controlling nucleation, we can control the formation of a mesostructured aggregate at a point where the hexagonal mesochannel axes will grow perpendicular to the substrate. This is accomplished by controlling the direction of solvent removal from the system, as well as controlling the relative concentrations of the solvent species present in the block copolymer/sol-gel solution. Moreover, as indicated in FIG. 1A through FIG. 1C, nucleation of inherently anisotropic hexagonal mesophase domains will continue to grow anisotropically, provided solvent removal continues to be anisotropic across the nucleation interface. If a majority (or many) such domains nucleate and grow in this manner from a common interface, a high degree of macroscopic orientational order is achieved.

### Example

### Soft Lithographic Micromolding Using PDMS Stamp

Control over the directions and rates of solvent removal in the patterned films can be accomplished by using a soft lithographic micromold stamp formed from a material with appropriate solubility and diffusion properties for the solvent species. The rates and directions of solvent and cosolvent removal from the self-assembling precursor solution depend on whether the solvent species diffuse preferentially into the stamp material versus evaporating at the air interfaces at the ends of the microchannels. The micromolding process therefore allows one to control the drying of the self-assembling block-copolymer/sol-gel solution confined within the patterned channels of a pre-made soft lithography mold and the substrate.

Of the numerous choices available for a soft lithographic stamping material, highly cross-linked poly(dimethylsiloxane) (PDMS) is a material that has several benefits. The absorption of water in PDMS can be partially controlled by varying the degree of cross-linking of the elastomer precursor. Additionally, PDMS is available commercially and can easily be formed into patterned stamps by polymerizing on a hard-silicon master pattern formed using standard photolithography techniques. PDMS is also sufficiently rigid so as to maintain the three-dimensional shape of micrometer-scale pattern features (with tolerable mechanical deformation) when removed from the master or applied to a surface. Cross-linked PDMS is clear, flexible, and easy to mechanically manipulate.

The capacity of the PDMS to absorb solvent is also an important factor for obtaining directionally oriented nucleation of an aligned hexagonal mesostructure, with higher capacity allowing for better control. Control over the rates and directions of absorption and diffusion of solvent (e.g., ethanol) and cosolvent (e.g., water) is particularly important for directing mesostructure alignment. Control can be achieved by controlling the atmosphere (i.e., partial pressures of solvent and cosolvent species) surrounding the PDMS stamp, as the solvent and cosolvent absorb into the stamp from the patterned precursor solution.

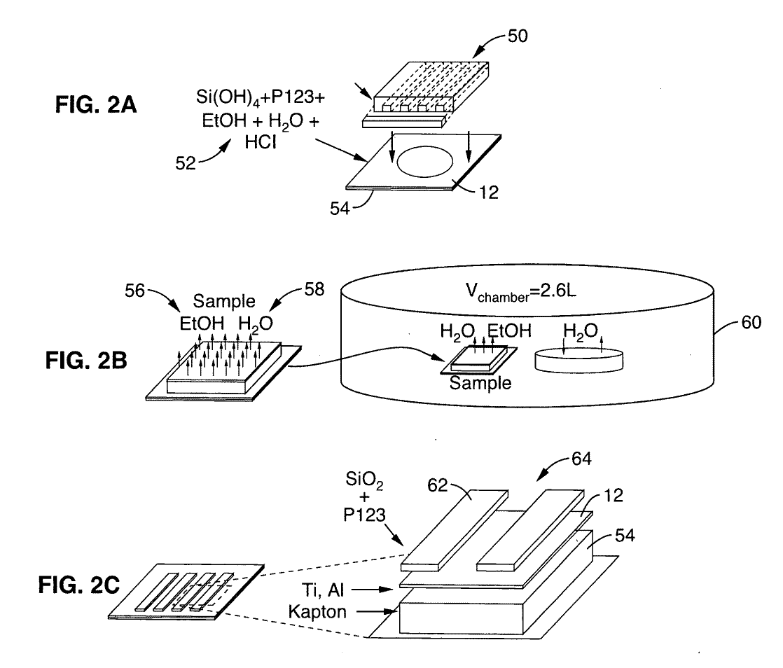

Referring also to FIG. 2A through FIG. 2C, an exemplary method of forming a patterned block-copolymer-templated mesostructured silica film by soft lithographic micromolding using a PDMS stamp according to an aspect of the invention is shown.

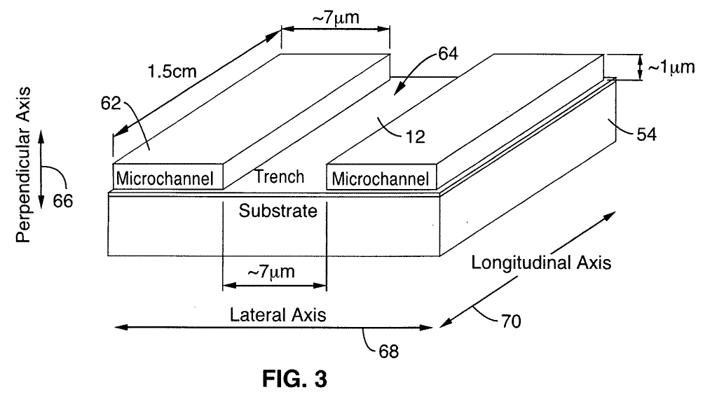

FIG. 2A is a schematic diagram depicting the method of applying a patterned PDMS stamp 50 onto 11 μL of a hydrolyzed block-copolymer/silica sol-gel precursor solution 52 using a metalized (titanium or aluminum) substrate 12 on a Kapton® support 54. The patterned PDMS stamp is applied to the block-copolymer silica sol-gel precursor solution which then fills the micron-sized channels, and the volatile solvent and cosolvent species absorb into the PDMS. Diffusion of the solvent/cosolvent species into the PDMS establishes concentration gradients that are sustained by evaporation at the stamp surface into the surrounding atmosphere, as illustrated in FIG. 2B which is a schematic diagram depicting absorption of solvent and cosolvent species (e.g., ethanol 56, water 58) into the PDMS and equilibration within a 2.6 L closed environmental chamber 60 kept at a constant relative humidity (RH) by use of an appropriate saturated salt solution. The rates of evaporation of the solvents from the PDMS can be affected by control of the partial pressures of the volatile species in the surrounding environment. Control of the water vapor partial pressure (relative humidity) can be fixed by using saturated salt solutions as illustrated by FIG. 2B. Typically, after 7 days at room temperature, the solvent and cosolvent species are completely removed, orientationally ordered mesostructured domains have formed, and the silica has polymerized into a rigid framework. The PDMS stamp can then be removed, leaving a patterned, mesostructured silica-block-copolymer film adhering to the metalized substrate, as shown in FIG. 3 which is a schematic diagram depicting the patterned block-copolymer-templated silica film 62 on the metalized Kapton® support after removal of the PDMS stamp. Kapton® (a polyimide, chemical name poly[4,4′-oxydiphenylene-pyromellitimide]) was used to allow characterization of the film by transmission X-ray diffraction, but is otherwise unnecessary. The metalized layer provided an oxide surface to which the patterned mesostructured film was found to adhere. In this example, the mesostructured block-copolymer/silica films were patterned into a series of channels 1.5 cm in length, and 1 μm in height, and uniformly 5, 7, 10, or 12 μm in width, according to the PDMS stamp/micromold features.

Referring also to FIG. 1A through FIG. 1C and FIG. 3, the long patterned channels 62 (FIG. 2C and FIG. 3) where the block-copolymer-templated mesostructured silica forms will be referred to as “microchannels,” while the individual self-assembled cylinders 20 (FIG. 1A through FIG. 1C) of the hexagonal mesostructure shall be referred to as “mesochannels.” The microchannels are separated by “trenches” 64 of constant width that are approximately equal to that of the microchannels, as depicted in FIG. 3. Each microchannel can be considered to have three different axes that are associated with the three different possible orthogonal orientations for the hexagonal mesostructure: perpendicular 66, lateral 68, or longitudinal 70 relative to the axes of the microchannels 62. In this example, the microchannels had a 1.5 cm length associated with their longitudinal axes, while various uniform 5, 7, 10, or 12 μm widths were associated with their lateral axes.

### Example

Alignment of Hexagonal Mesostructured Block-Copolymer-Templated Silica Films

Here, we describe in detail a reliable and reproducible method for obtaining hexagonal inorganic-organic mesostructures with high degrees of macroscopic orientational order. By simultaneously controlling the directions and rates of solvent removal and interface hydrophobicity/hydrophilicity, it is possible to control the location at which nucleation of mesostructural domains occur and influence their direction of growth. This can be achieved by using soft-lithography to prepare patterned, hexagonally mesostructured block-copolymer/silica films with controlled alignment and pores/channels that can accommodate orientationally ordered photo-responsive guest molecules.

### Materials and Methods

The general method for preparing aligned mesostructural composites involves the creation of a patterned PDMS stamp to be used as a micromold for directing the patterning of the mesostructured silica/P123 as it forms from a block-copolymer sol-gel precursor solution on a metalized substrate. The drying period extends over a period of 6-7 days under fixed environmental conditions that control the rate(s) of solvent/co-solvent species removal from the precursor solution. After the drying period, the PDMS stamp is removed, leaving the patterned mesostructured material on the substrate for characterization by SAXS, and cross-sectional TEM.

Four-inch silicon [100] wafers (Wafer World Inc., West Palm Beach, Fla.), were patterned by photolithography and subsequently used as a master replica from which patterned micromold PDMS stamps were prepared. The master pattern was formed by spin-coating photoresist AZ5214, developed according to a desired pattern, followed by 6 s etch cycles for a total of 30-36 s. After coating the silicon wafer with 1H,1H,2H,2H-perfluoro-decyltricholorosilane to prevent significant adhesion of the PDMS to the silicon surface, a mixture of Sylgard® 184 elastomer and a dimethyl-methylhydrogen siloxane curing agent in a 10:1 ratio was poured on top of the patterned silicon master and cured overnight at 65° C. under vacuum. The pattern imprinted onto the PDMS stamp was comprised of long microchannels 1.5 cm in length, 1 μm in height, and 5, 7, or 12 μm in width. The thickness of the stamps above the channels was controlled by adjusting the amount of elastomer poured on top of the patterned silicon master.

Thin metalized Kapton® was used as a substrate for the films, providing a smooth surface for film deposition. The Kapton® support is transparent to X-rays and allows for efficient characterization of the mesostructured silica by transmission-mode SAXS. Substrates for the films were prepared by depositing titanium metal via physical vapor deposition methods using an electron beam evaporator and a 99.999% titanium source. Titanium metal was chosen because of its excellent corrosion resistance under the acidic conditions of the synthesis. The titanium was deposited onto a 0.05 inch thick Kapton® support (DE350—Dunmore Corporation, Bristol, Pa.) or a thin borosilicate glass slide. The glass slide was used when calcination was performed to remove the structure-directing triblock copolymer surfactant species at temperatures at which the Kapton® would not withstand.

Glass desiccators having a volume of 2.4 L were used as an environmental chamber to achieve a 97% relative humidity. The relative humidity was controlled by placing a saturated salt solution of K₂SO₄, while at a constant temperature of 25° C. Other relative humidity environments (percents shown) were created using different saturated salt solutions: KCl (84%), Kl (69%), Mg(NO₃)₂ (54%), MgCl₂ (33%).

The mesostructured silica films were synthesized by solution precipitation in the presence of amphiphilic triblock copolymer species. Soluble silica precursor species were prepared by hydrolyzing tetraethoxysilane, (TEOS, Aldrich Chemicals) in an acidic, ethanol-based solution at room temperature for one hour. A second solution containing the amphiphilic triblock copolymer species poly(ethylene oxide)-poly(propylene oxide)-poly(ethylene oxide) (EO₂₀PO₇₀EO₂₀, Pluronic® P123, BASF, Mount Olive, N.J.) was separately prepared by dissolution in ethanol at room temperature, after which the two solutions were combined and mixed under stirring for one hour. In a typical synthesis, the molar ratio of materials used was 1 TEOS:0.0172 P123:22.15 EtOH:0.02HCl:5.00H₂O. 11 μL of this triblock-copolymer/silica sol was then placed on a metalized substrate (typically titanium-coated Kapton® or glass), after which the patterned PDMS stamp (thickness ˜1 mm) was placed down on top of the solution and pressure applied in such a manner that the entire stamp area was wetted. The solution was allowed to dry over a period of several days to 1 week in a fixed volume chamber maintained at 97% (or other) relative humidity. After drying, the PDMS was carefully removed, leaving the patterned, mesostructured silica-P123 film adhering to the substrate surface.

Similar mesostructured silica-P123 films were prepared using the more hydrophobic solvent tetrahydrofuran (THF). In this case tetraethoxysilane, (TEOS, Aldrich Chemicals) was hydrolyzed in an acidic, tetrahydrofuran-based solution for one hour and then mixed with a solution of EO₂₀PO₇₀EO₂₀, (Pluronic® P123) triblock copolymer species also dissolved in tetrahydrofuran. In a typical synthesis, 1.17 mL of THF, 0.23 mL of TEOS, and 0.09 mL of 0.07 M HCl were mixed at room temperature in a small vial, then added to 0.09 g of Pluronic® P123 to dissolve the surfactant, followed by the addition of another 2.2 mL of THF. As above, the mixed precursor solution was then placed on a metalized substrate (typically titanium-coated Kapton® or glass), after which the patterned PDMS stamp (thickness ˜1 mm) was placed on top of the solution and pressure applied in such a manner that the entire stamp area was wetted. The solution was allowed to dry over a period of 2 days in a fixed volume chamber maintained at 53% relative humidity through a saturated salt solution of NaBr, after which the stamp was removed.

After removing the stamp and drying in room temperature air overnight, removal of the structure-directing triblock copolymer species was achieved by calcining the mesostructured silica-P123 films in air. The temperature of the oven was ramped from 25° C. to 500° C. at 1° C. per min, then held for eight hours and allowed to cool. After calcination, 2D SAXS measurements were conducted to confirm that the mesostructural order and alignment were still present, and to assess any changes in d-spacing.

Small-angle X-ray scattering (SAXS) measurements were made using an ultra-SAXS diffractometer with a copper anode (λ=1.54 Å) and a two-dimensional (2D) image plate with a sample-to-detector distance of 1.725 m. An intermediate-SAXS (i-SAXS) diffractometer with similar features, but a sample-to-detector distance of 0.758 m, was also used.

Cross-sectional TEM micrographs were obtained using a FEI Tecnai T20 electron microscope operating at 200 keV. Samples were prepared using a FEI DB235 Dual-Beam Focus Ion Beam System to cut 150-nm-thick samples out of individual microchannels with a Magnum ion column operating at 300 pA.

### Results and Discussion

(a) Spectrographic Analysis

The mesostructural and orientational ordering of patterned silica/block-copolymer films can be characterized by small-angle X-ray scattering (SAXS) and focused ion-beam (FIB) transmission electron microscopy (TEM). SAXS scattering measurements are routinely used in the study of mesoscale materials, because they provide information on the mesostructural ordering of the silica/block-copolymer films. Analysis of the azimuthal distribution, that is, variance in scattering intensity at differing distances from the center of the diffraction pattern, allows one to infer the presences of different lattice planes in the mesostructured material. The presences of particular lattice planes are associated with different phases with different mesostructural ordering. For example, it is known that the diffraction pattern of a cubic mesostructure will contain principally the (100), (200), and (211) diffraction planes, whereas a hexagonal mesostructural will contain principally the (100), (200) and (300) planes (and several others possibly present depending on the orientation of the mesostructure). The number of diffraction planes present is also a measure of the degree of mesostructural ordering, with more diffraction planes corresponding to higher long-range ordering. Likewise, analysis of the radial distribution (i.e., in a circle at a fixed distance from the center of the diffraction pattern) provides information on the orientation of particular lattice planes relative to the X-ray beam. A circular (ring) diffraction pattern is characteristic of an isotropically oriented sample. Diffraction “spots” are characteristic of alignment in a particular diffraction plane, where the width of the spot (i.e., how narrow the distribution of intensity) allows for the quantification of the degree of alignment. Through analysis of a 2D SAXS diffraction pattern, one can therefore characterize the degrees of alignment and mesostructural ordering.

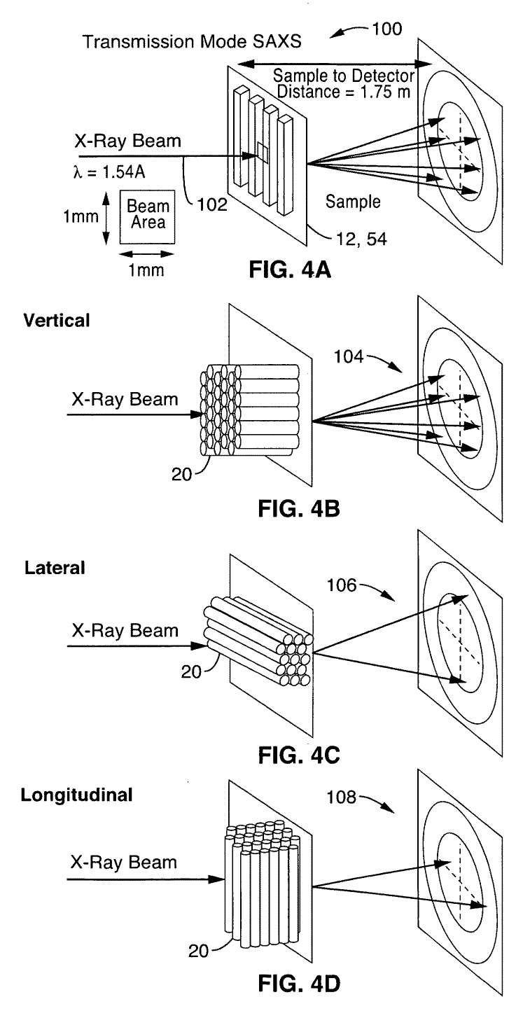

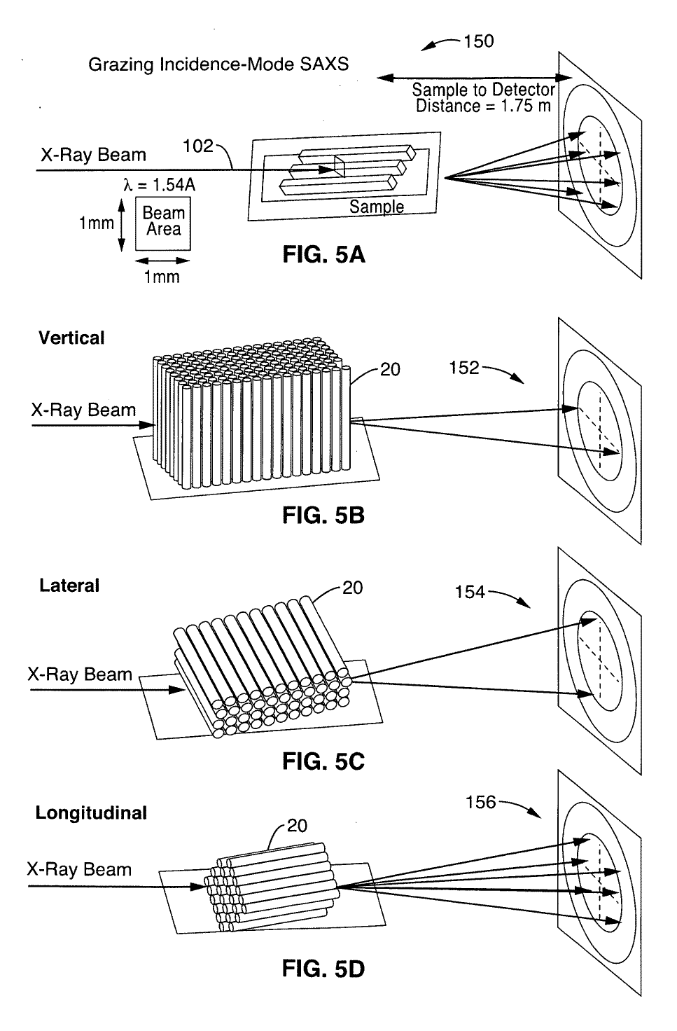

The expected diffraction pattern from a patterned silica/block-copolymer film varies greatly depending on the direction of alignment of the hexagonal mesostructure and the orientation of the sample relative to the incident X-ray beam. FIG. 4 and FIG. 5 show the experimental setup and expected diffraction patterns for transmission-mode 100 and grazing-incidence-mode 150 diffraction measurements (GI-SAXS), respectively. In transmission-mode SAXS, the film is positioned so that the X-ray beam 102 is 90 degrees relative to the metalized substrate 54,106, as illustrated in FIG. 4A. Vertical alignment in the patterned silica/block-copolymer hexagonal mesostructure will result in a 6-spot diffraction pattern 104, as illustrated in FIG. 4B, whereas laterally or longitudinally aligned mesostructures will yield different two-spot patterns 106, 108, illustrated by FIG. 4C and FIG. 4D respectively.

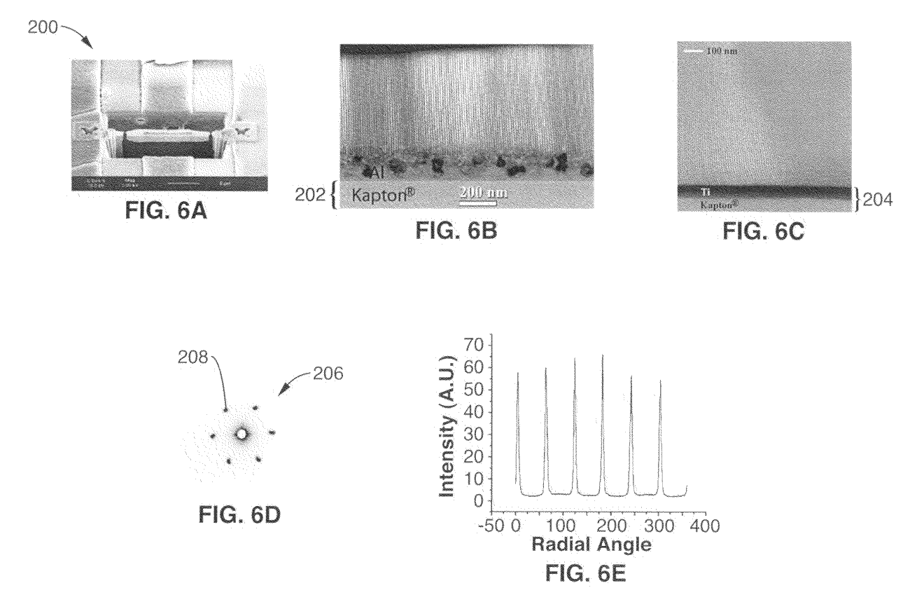

In GI-SAXS, the sample substrate is almost parallel to the X-ray beam 102 (approximately 2-3° off the beam path), as illustrated in FIG. 5A. The changing of the sample orientation from transmission-mode results in a changing of the scattering planes present in the diffraction pattern. Here, a vertically aligned hexagonal mesostructure will result in two diffraction spots along the horizontal axis of the diffraction pattern 152, as illustrated in FIG. 5B. Similarly, a laterally aligned hexagonal mesostructure will result in two diffraction spots along the vertical axis of the diffraction pattern 154, as illustrated in FIG. 5C, and a longitudinally aligned hexagonal mesostructure will yield a 6-spot diffraction pattern 156, as illustrated in FIG. 5D. The predictability of these diffraction patterns allow for one to easily match the experimental diffraction patterns, for example pattern 206 in FIG. 6D, to those in FIG. 4 and FIG. 5 to determine the direction(s) of alignment present in a patterned silica/block-copolymer film sample.

In addition to SAXS, FIB TEM is a desirable tool for the characterization of silica/block-copolymer films to ascertain details of the mesostructural ordering on a nanometer scale that are not provided by SAXS. TEM samples are prepared by using a focused ion beam (FIB) to cut thin (approximately 125-200 nm) cross-sectional slices of the patterned film. The example shown in FIG. 6A is 6 μm in height (including the substrate) and 15 μm in width. In general, cross-sectional samples may be prepared with the width directed across or down the microchannel or at an arbitrary angle to investigate the mesostructural ordering at different points in the microchannel. Such sample preparations are desirable to investigate the behavior of the hexagonal mesostructure throughout the entire film thickness, as opposed to only the surface of the mesochannels in a non-cross-sectional TEM sample or in high resolution SEM. FIG. 6A illustrates one such cross-channel-milled sample 200. Using electron microscopy, it is possible to learn useful details about the degree of alignment between the substrate and the film surface, e.g., the length of a single mesochannel and to establish whether defects are present. One can also establish whether the mesochannels are parallel, perpendicular, or tilted with respect to the substrate. The form or shape of the film surface can also be qualitatively characterized to assess imperfections in the film, such as may result from imperfections in the PDMS stamp or micromolding process. These details not only help confirm the interpretation of the X-ray patterns, but also provide insight into the mesostructural order and formation mechanism.

(b) Substrates

The acidic conditions of the silica and block copolymer precursor species are necessary for the co-assembly of the organic and inorganic species, but create additional considerations for choosing the substrate material. The addition of acid into the silica precursor solution, as described above, is required for the hydrolysis of the TEOS silica source. The TEOS hydrolyzes into Si(OH)₄ and later cross-links to form the inorganic matrix of the silica-P123 mesostructured film. However, the low pH (˜1.75) of the silica and block copolymer precursor solution also serves to slow the silica cross-linking reaction. If the mesostructured silica-P123 film is to form, the cross-linking of the silica should occur after self-assembly of the P123 polymer species. After self-assembly, the silica can then polymerize, fixing the organic. However, the acidic conditions also can cause corrosion of the metalized substrate used to provide a smooth surface for film growth. This corrosion is evident in the TEM image showing the aluminum-coated Kapton® substrate 202 in FIG. 6B.

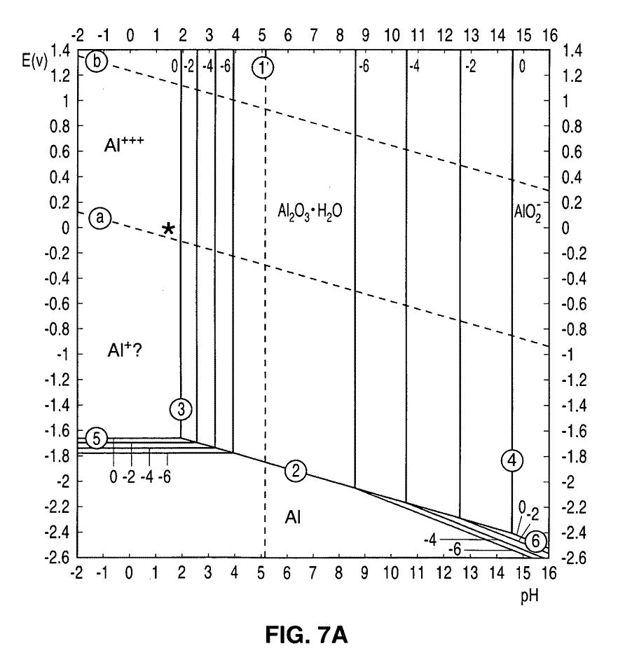

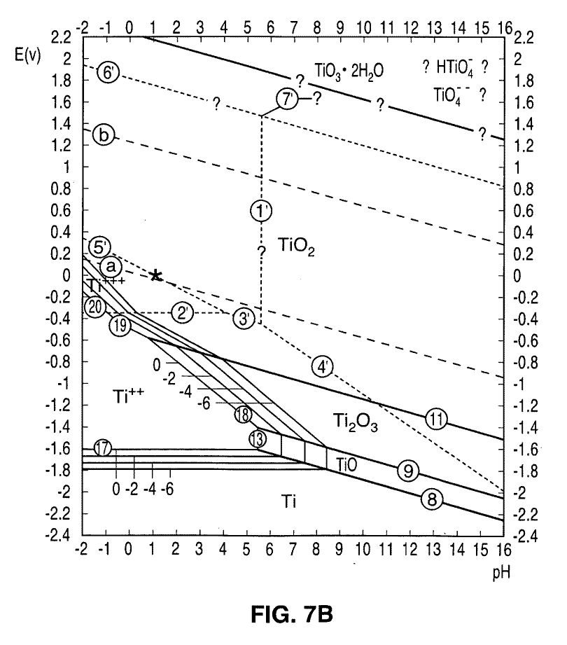

FIG. 7A and FIG. 7B are Pourbaix diagrams of aluminum and titanium, respectively, showing the various oxidation states present in the metal, which are dependent upon the pH and potential of the aqueous solution at 25° C. The star indicates the position on the chart that is applicable to the synthesis conditions of the silica-P123 sol. Pourbaix diagrams are a useful tool for assessing the stability of a metal at a particular pH and potential. FIG. 7A shows that at a potential of 0 eV, aluminum metal readily dissolves into Al³⁺ ions at pH<4, resulting in the corrosion apparent in FIG. 6B. At this potential, aluminum is pacified against corrosion when in the oxide form Al₂O₃. Corrosion also occurs at pH values above pH 11, as the metal dissolves into AlO₂⁻ ions. In stark contrast, compare FIG. 6B with FIG. 6C which is a TEM image of similar sample formed on a titanium-metalized Kapton® substrate 204. Titanium is corrosion-resistant across a wide range of pH at 0 eV and 25° C., including the conditions that apply to the silica-P123 precursor solution.

Therefore, subsequent patterned and mesostructured P123/silica films were prepared on a substrate of titanium-coated Kapton® or glass, as described above. The titanium-coated substrate allows a low enough pH in the silica-P123 precursor solution to sufficiently slow the polymerization of the silica, while not corroding the metalized substrate.

(c) Vertical Alignment

Such characterization methods were applied to assess the degree and direction of orientational ordering of mesostructured films prepared under the conditions described above. When the block copolymer sol-gel precursor solution was allowed to dry under the micro-patterned PDMS stamp in an atmosphere with high relative humidity, the mesostructured composite film aligned with a large fraction of the hexagonal mesochannels perpendicular to the substrate. The alignment of the mesostructure was first characterized through SAXS to confirm the vertical alignment before using FIB to obtain a cross-sectional TEM image.

The 2D transmission-mode SAXS diffraction pattern 206 shown in FIG. 6D shows six sharp hexagonally-arranged diffraction spots 208 with d-spacings of 13.0 nm that establishes both a high degree of hexagonal mesostructural ordering and vertical alignment of the cylindrical mesochannels relative to the substrate. The sharp six-spot pattern indicates a highly ordered hexagonal mesostructure that is aligned parallel to the direction of the incident X-ray beam, in this case, normal to the substrate (FIG. 4B). The 2D radial integration of this pattern yields the narrow (4° FWHM) reflections shown in FIG. 6E, consistent with its very high degree of mesostructural order.

To prepare a TEM sample, a focus ion been was used to cut a cross-sectional slice into a single 1 μm high by 7 μm wide microchannel, shown in FIG. 6A before mounting onto a TEM grid. The corresponding cross-sectional FIB TEM images shown in FIG. 6B and FIG. 6C, confirm the high degree of vertical alignment of the hexagonal silica-P123 mesostructure. The alignment persists through the entire 600 nm film thickness with only a slight pitch of the vertical pores. In almost all of the TEM samples examined, the degree of alignment is constant across the entire width of the microchannel. The presence of such a highly aligned mesostructure in both titanium and aluminum coated Kapton® substrates shows that the alignment mechanism is largely independent of the metal at the bottom solid substrate surface. It has also been found that in samples showing vertical alignment, mesochannels near the microchannel edge will bend slightly, orienting toward microchannel corner, supporting the hypothesis that nucleation results from mass transfer into the stamp and may involve some solvent transfer into the sides of the PDMS stamp. The cross-section reveals that the total thickness of the mesostructured silica-P123 film is approximately 600 nm, in contrast to the 1000 nm high microchannels of the stamp pattern. This is likely due to shrinkage occurring as the block copolymer/silica sol dries and the silica precursor species cross-link.

We believe that the vertical alignment of the mesostructure results principally from absorption and diffusion of the solvent and cosolvent species into the PDMS itself, rather than evaporation-induced self-assembly. Here, the aim is to test and generalize this hypothesis by selecting and controlling whether the solvent species are removed by diffusion or evaporation and the interfaces and directions where these processes occur. For example, if the stamp is not saturated with solvent, continuous absorption, diffusion, and removal of the solvent species will occur into the stamp. This results in a concentration gradient that eventually results in the solvent concentration within the microchannels diminishing to the point where self-assembly of the structure-directing block copolymer species can take place. The point(s) in the microchannels where this first occurs is expected to be nearest the points where the solvent is being most rapidly removed. These will be at either at the PDMS or air interfaces along or at the ends of the microchannels, where nucleation and growth of the mesostructure composite is expected to occur. Provided such mesophases nucleate, grow, and fill the microchannels before the silica cross-links and solidifies, formation of thermodynamically favored mesostructure domains with high degrees of mesoscopic and orientational order are expected to result.

To control the alignment of cylinders in hexagonal mesostructured domains, a system is preferably selected in which a hexagonal phase is thermodynamically favored and takes into account the relative surface properties of the self-assembling block-copolymer components and the interface at which mesophase nucleation occurs. Phase selection can be achieved, based on guidance from available (often ternary) phase diagrams and the expected compositions of the final block-copolymer silica composite (assuming complete removal of solvent species and that the silica can be classified as a hydrophilic component). For Pluronic®-type triblock-copolymer species, the silica and PEO components form continuous hydrophilic regions, while the PPO blocks are relatively hydrophobic. For the case of EO₂₀PO₇₀EO₂₀ (P123) in mixed water/alcohol solutions, a relatively large region exists at low alcohol concentrations over which the hexagonal (H₁) phase forms. As the water and ethanol solvent species are removed by diffusion into the PDMS stamp or evaporation from an air/sol interface, the system follows a trajectory through a complicated multi-component phase diagram. Nucleation of liquid-crystal-like mesophases occurs when and where the solvent composition drops to the point where dense aggregates first form. As the solvent concentration continues to drop, a mesophase (e.g., hexagonal) develops and grows. Because solvent is being depleted from the microchannels into the PDMS stamp or across an air interface at the channel ends, nucleation will invariably occur at whichever of these interfaces the flux of solvent is the greatest.

The orientations of the intrinsically anisotropic hexagonal domains at their nucleation sites depend on whether either of the hydrophilic PEO/silica or hydrophobic PPO moieties preferentially interact with the interface at which nucleation occurs. Because PDMS is relatively hydrophobic, the relatively hydrophobic PPO cylinders of hexagonal P123-silica domains will tend to maximize their contact with the PDMS surface, according to the balance of surface and bulk phase energies. For example, orientational ordering of hexagonally mesostructured domains can occur, such that the PPO cylinders are oriented perpendicular to the PDMS interface and the metalized substrate. This appears to occur because the solvent species (here, ethanol, water, and/or THF) are removed approximately unidirectionally from the patterned microchannels into the PDMS stamp, fixing the nucleation interface for the mesostructure at the top microchannel surfaces.

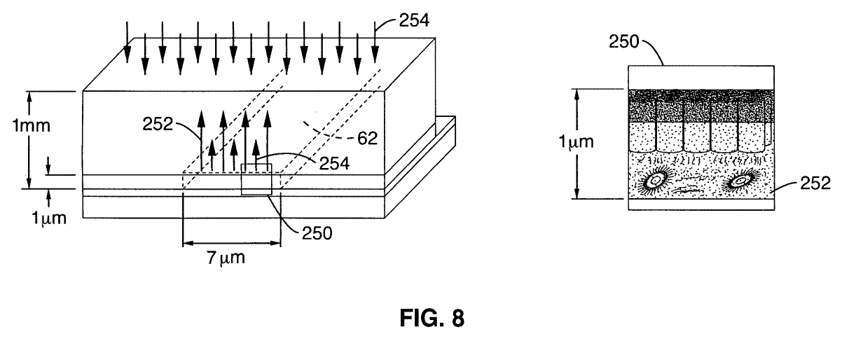

FIG. 8 schematically depicts a route of solvent removal into a non-saturated PDMS stamp and initial nucleation of the hexagonal mesostructured silica when allowed to dry in the patterned microchannels according to an aspect of the invention. The inset image 250 shows nucleation of the hexagonal mesostructure at the PDMS interface, as well as micellization of the triblock copolymer species in the solution below the nucleating front. The longer arrows 252 of the solvent represent the increased flux of the solvent, e.g., ethanol or tetrahydrofuran, compared to water illustrated by the shorter arrows 254. Channel dimensions have not been drawn to scale.

As shown in FIG. 8, solvent species enter the underside of the patterned stamp (which is initially devoid of water and ethanol), causing the block copolymer sol-gel precursor solution in the microchannels to dry. Eventually, the solvent concentration in the microchannels, and first at the PDMS interface, is reduced to the point that a liquid crystalline mesophase can form.

We believe that nucleation occurs at the corners of the microchannel/PDMS interfaces, where the solvent flux is expected to be highest. The hydrophobicity of the PDMS surface yields preferential contact with the hydrophobic PPO regions/moieties of the structure-directing triblock copolymer species (in this case, Pluronic® P123), promoting perpendicular alignment of the mesostructure, as domains grow downward toward the titanium-coated Kapton® substrate. We have also observed that the locations of the six diffraction spots do not vary between samples or along the longitudinal axes of the microchannels. This indicates that there is a preferential orientation for the hexagonal mesostructure as each domain nucleates, supporting the hypothesis that the alignment of the mesostructure is a result of solvent removal into the PDMS stamp and giving the mesostructure crystal-like ordering over macroscopic (˜1 cm) length scales. These results indicate that nucleation appears to first occur at the microchannel corners of the PDMS stamp pattern, where solvent flux is expected to be the highest, and then progress inward toward the center of the microchannel and downward to the lower substrate. Along the two corners of each microchannel, the side walls of the PDMS stamps may influence mesostructure growth and thus alignment. The net effect is that the hexagonal mesostructure aligns with the same orientation at all points along the microchannel and with few grain boundaries in the final film (presumably because they self-anneal prior to silica cross-linking).

We achieved similar mesostructural ordering and alignment using a more hydrophobic solvent, specifically THF. PDMS-patterned silica-P123 films were prepared from THF precursor solutions using similar methods as described above, although the most reproducible alignment occurred when drying occurred at 53% relative humidity. When THF is used as a solvent, the drying rate increases dramatically, with the patterned silica-P123 mesostructure formed within 48 h, as opposed to the six to seven days required when using ethanol as the principal solvent. THF is more volatile than ethanol, yet the difference in their vapor pressures at room temperature does not account for the dramatic difference in drying rates. Instead, it is better explained by the increased solubility of THF in the PDMS stamp, leading to an increased diffusive flux of THF out of the microchannel. It should be noted that PDMS swells to a much higher extent in THF, which can cause difficulties in the stamping process. In the presence of high concentrations of THF, the PDMS stamp can curl away and delaminate from the substrate, disrupting confinement of the block-copolymer/silica sol and control of the solvent removal direction. The problem of PDMS swelling was found to be diminished as the PDMS thickness increased, presumably because of a small concentration gradient and lower swelling stresses within the stamp. Mesostructured silica films prepared from THF solvents were therefore achieved using PDMS stamps with an average thickness of 8 mm.

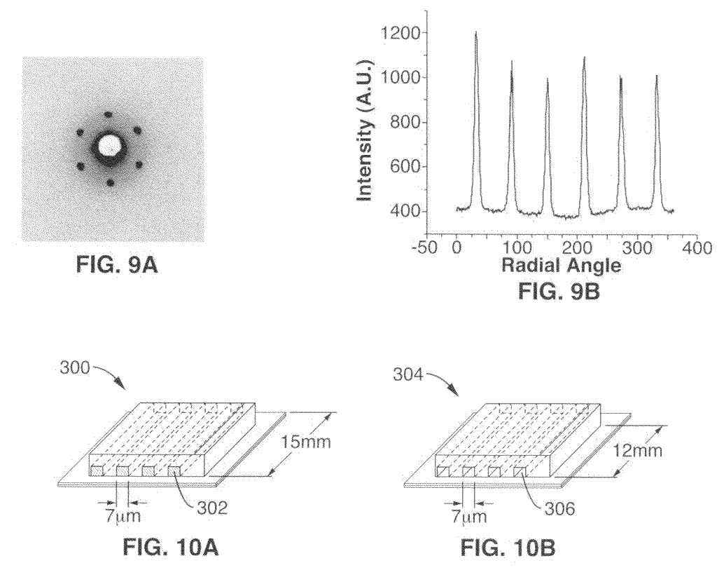

FIG. 9A shows the transmission-mode SAXS diffraction pattern of a patterned and mesostructured P123-silica film on titanium-metalized Kapton® substrate, synthesized as described herein. The sharp six-spot pattern indicates a highly ordered hexagonal mesostructure that is aligned parallel to the direction of the incident X-ray beam, in this case, normal to the substrate. FIG. 9B illustrates 2D radial integration of the SAXS pattern acquired in transmission-mode (see FIG. 4A).

The 2D SAXS pattern, FIG. 9A, shows that the P123/silica mesostructure contains a high degree of alignment perpendicular to the substrate. The presence of 2^{nd}-order reflections indicates that a high degree of mesostructural ordering is also present. The 2D radial integration of this pattern yields the narrow (˜6° FWHM) reflections shown in FIG. 9B. The achievement of a highly aligned, vertically oriented silica-P123 mesostructure using THF as a co-solvent shows how the self-assembly and alignment mechanism hypothesized above may be generalized to a wide range of cosolvents that can be absorbed into the pattern-directing PDMS stamp.

It is our belief that alignment of the hexagonal silica-P123 mesostructure can achieved by controlling the flux of the solvents/co-solvents into the PDMS and that the degree of alignment should be consistent along the entire longitudinal axis of the microchannel, if end effects are not present. To support this belief, we synthesized patterned, hexagonally mesostructured silica-P123 films using PDMS stamps with the ends of the microchannels either closed off by the PDMS (where end effects along the microchannel axes will be minimized) as illustrated by the structure 300 with closed ends 302 shown in FIG. 10A, or cut open to expose the block copolymer sol-gel precursor solution to the atmosphere (where end effects along the microchannel axes will be significant) as illustrated by the structure 304 with open ends 306 shown in FIG. 10B. In this example, the microchannels were 5 μm to 12 μm in width. Microchannel dimensions have not been drawn to scale in these figures.

In both cases, the 2D transmission-mode diffraction pattern showed alignment of the hexagonal phase perpendicular to the substrate. In cases where the microchannel ends were exposed to the atmosphere, the degree of perpendicular alignment decreased closer to the microchannel ends. By comparison, for cases where the ends of the microchannels in the PDMS stamp were closed to the atmosphere, the degree of vertical alignment of the hexagonal mesostructured silica-P123 appeared not to vary along the 15 mm lengths of the ensemble of microchannels examined within the 1 mm² X-ray beam.

We believe that, when the microchannel ends are left exposed to the atmosphere, a portion of the solvent is able to evaporate into the surroundings, instead of diffusing into and through the PDMS stamp, resulting in multiple directions of solvent removal and thus, lower extents of orientational ordering in these regions. These observations correlate with our belief that solvent removal from the block-copolymer/silica sol in the center of the stamped region occurs principally via diffusion into the stamp, primarily perpendicular to the underlying substrate, leading to high extents of vertically aligned hexagonal mesostructured domains that appear to persist over macroscopic (˜1 cm) length scales. Near the open microchannels ends at the stamp edges, solvent evaporation at the air interfaces can also contribute to solvent removal, disrupting mesostructural alignment.

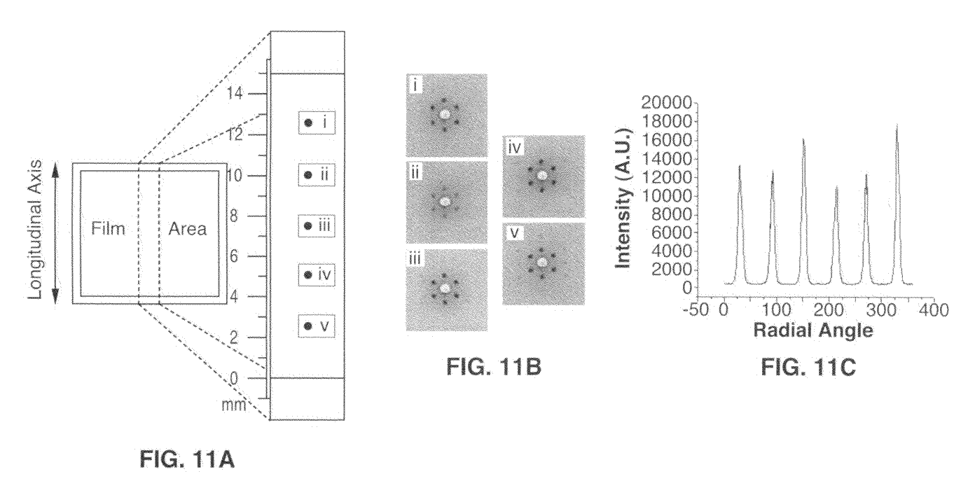

These beliefs were validated by small-angle X-ray scattering results that characterize mesostructural order and alignment at different regions across the macroscopic dimensions of patterned silica-/P123 films. For example, FIG. 11A and FIG. 11B show a series of SAXS patterns acquired from such a film at different locations along the longitudinal axes of the patterned microchannels. FIG. 11A shows the different locations with respect to the film area where the 2D SAXS patterns were acquired along the 15 mm longitudinal axes of an ensemble (1 mm² X-ray beam spot) of 1 μm×7 μm microchannels of a PDMS-patterned hexagonally mesostructured silica-P123 film in which the microchannel ends were closed. FIG. 11B shows 2D SAXS patterns taken from locations i-v depicted in FIG. 11A. FIG. 11C illustrates 2D radial integration showing the high degree of alignment of SAXS pattern iii.

The film examined was prepared by using a PDMS stamp with closed microchannel ends and allowing the block-copolymer/silica precursor sol to dry in a controlled atmosphere at 97% relative humidity, as depicted in FIG. 2B. Over the 15 mm width of the stamp, a high degree of hexagonal mesostructural order and alignment exist, both in the center of the micro-stamped region and near the closed ends near the stamp edges.

The 2D radial integration of a representative SAXS pattern (pattern iii in FIG. 11B), shown in FIG. 11C, for which an overall degree of alignment of approximately 6 degrees FWHM was measured from the narrow reflections. The ability to control the alignment of the mesostructure over a large macroscopic length scale is desirable for many of the desired applications of these materials.

When the ends of the longitudinal axes of the microchannels are open, an interface exists between the block-copolymer/silica precursor sol and the atmosphere, which allows evaporation of volatile solvent and cosolvent species. According to the proposed hypothesis on the mechanism for alignment of the hexagonal silica-P123 mesostructure described above, the evaporative end-effects are expected to contribute to the flux of solvent and cosolvent species and potentially disrupt the mesostructural alignment near the open microchannel ends.

Further validation of our hypotheses on alignment of the hexagonal silica-P123 mesostructure were provided through X-ray scattering results that characterize mesostructural order and alignment at different regions across the macroscopic dimensions of the patterned silica-P123 film, focusing near the ends of the microchannel axes. It is in this region that effects from evaporation at the block copolymer/silica sol and air interface would be most prevalent.

A mesostructured silica film examined was prepared by using a PDMS stamp with its microchannel ends exposed to the surrounding environment and allowing the block-copolymer/silica precursor sol to dry in a controlled atmosphere at 97% relative humidity, as depicted in FIG. 2B. The 2D SAXS patterns were then obtained.

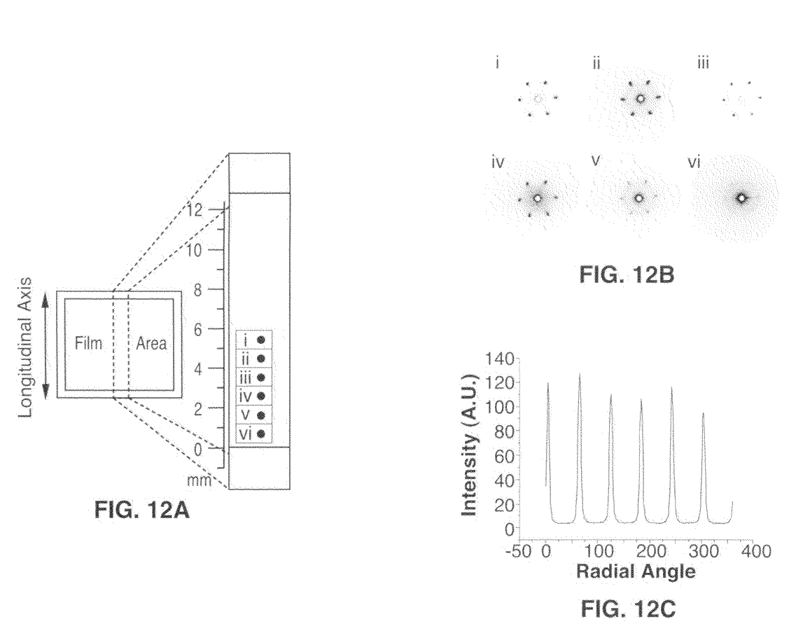

FIG. 12A shows the different locations with respect to the film area where the 2D SAXS patterns were acquired along a 12 mm longitudinal axes of an ensemble (1 mm² X-ray beam spot) of 1 μm×7 μm microchannels of a PDMS-patterned hexagonally mesostructured silica-P123 film in which the ends of the microchannel axes were exposed to the atmosphere. FIG. 12B shows the 2D SAXS patterns taken from locations i-vi depicted in FIG. 12A. FIG. 12C illustrates 2D radial integration showing the high degree of alignment of SAXS pattern i. Referring to FIG. 12B, starting with pattern i, the 2D SAXS pattern shows a sharp six-spot intensity pattern that establishes vertical alignment of the hexagonal mesostructure at the center of the microchannel axes, indicating that the effects of evaporation at the microchannel do not propagate deep into the interior film regions. The mesostructural ordering and alignment decreases progressively along the microchannel axes moving nearer to the air interface. This observation is consistent with the hypothesis that the mesostructural ordering and alignment in PDMS-patterned silica-P123 hexagonal films are achieved through control over the flux of the solvent and cosolvent species as the block-copolymer/silica precursor solution dries.

The observations concerning the differing degrees of alignment, depending on whether the microchannel PDMS stamp ends are open or closed, illustrates the importance of controlling the rate and direction of mass transfer of the solvent/cosolvent species as the block-copolymer/silica precursor solution dries. To explore the effects of varying the concentration of water in the film as the mesostructure self-assembles, ethanolic block-copolymer/silica sol-gel precursor solutions were prepared and dried using a thin (˜1 mm) patterned PDMS stamp with open microchannel ends. The stamped films were allowed to dry in environments with differing fixed relative humidities, as depicted in FIG. 2B, at room temperature and their 2D SAXS patterns compared.

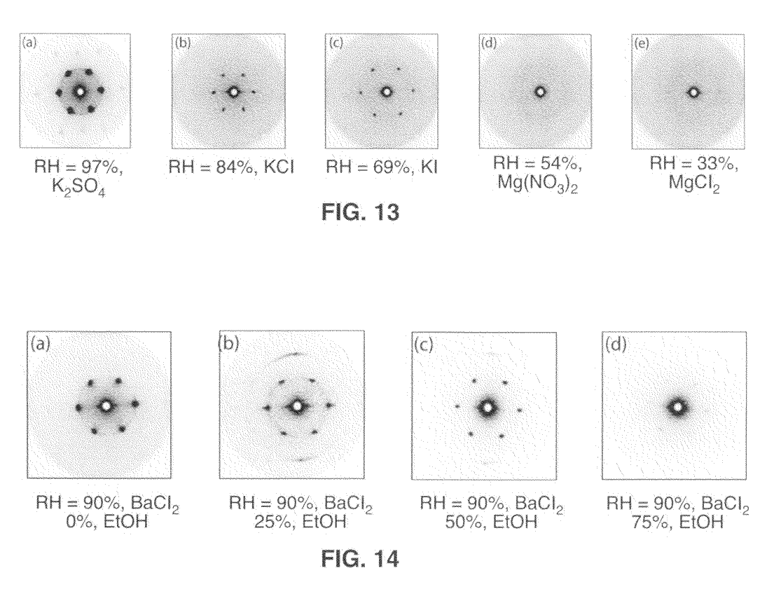

Refer, for example, to FIG. 13 which shows 2D SAXS patterns of mesostructured silica-P123 films with 1 μm high×7 μm wide×˜12 mm long microchannels formed from an ethanol/water solution patterned using a PDMS stamp under fixed relative humidities of (a) 97%, (b) 84%, (c) 69%, (d) 54%, and (e) 33% at room temperature, according to the water contents in the vapor phase above each of the saturated salt solutions indicated. All SAXS patterns were acquired from the same relative positions of the PDMS-patterned films, at approximately the centermost point of the film area. The 2D SAXS patterns shown in FIG. 13 of films of otherwise identically patterned silica-P123 films dried under PDMS stamps at different relative humidities show very high extents of mesostructural ordering and vertical alignments, FIG. 13, panel (a), when high environmental humidities are present (˜97% R.H.). Careful inspection of the SAXS pattern in FIG. 13, panel (a) reveals the presence of three orders of reflections with sharp six-spot patterns. At lower relative humidity values of 84% R.H. and 69% R.H., sharp six-spot SAXS patterns are also present, but they are less intense, and only single orders of reflections are visible as shown in FIG. 13, panels (b), (c). For relative humidities of 54% and below, (FIG. 13, panels (d), (e)), little or no mesostructural ordering or alignment is apparent. It is hypothesized that the improved mesostructural order observed at high humidities is due to the slower removal of water from the drying film, which slows the rate of silica cross-linking, thereby preventing the premature solidification of the silica matrix before the triblock copolymer species can self-assemble and direct both mesostructural and orientational order in the film. Thus, mesostructural and orientational order are influenced by the relative humidity around the PDMS stamp. Consequently, one would expect that variance in the partial pressure of ethanol might to also affect the rate of diffusion of the solvent from the ethanolic block-copolymer/silica sol-gel precursor solution through the PDMS stamp, thereby affecting mesostructural and orientational ordering of the films. The partial pressure of ethanol in the environmental chamber was initialized at various fractions of saturation by evaporating small masses of the cosolvent into the environmental chamber, as calculated based on the equilibrium vapor pressure at 25° C.

Characterization of the mesostructural ordering and alignment was accomplished by 2D SAXS, as shown in FIG. 14 which shows 2D SAXS patterns of mesostructured silica-P123 films with 1 μm high×7 μm wide×˜12 mm long microchannels formed from an ethanol/water solution patterned using a PDMS stamp under a fixed relative humidity of 90% at 25° C., according to the water content in the vapor phase above the BaCl₂ saturated salt solution. The saturation fraction of the ethanol in the vapor phase of the environmental chamber was initialized to fractions of (a) 0%, (b) 25%, (c) 50%, and (d) 75%, based on preliminary evaporation of a fixed quantity of ethanol (determined by calculation of mass required to achieve an ethanol partial pressure in the vapor equal to the vapor pressure at 25° C.). All SAXS patterns were taken from the same relative positions of the PDMS-patterned films, at approximately the centermost point of the film area.

These SAXS patterns reveal a similar and consistent effect on the mesostructural ordering and alignment as observed for the variation of the water content in the atmosphere surrounding the PDMS stamp (FIG. 13). At lower fractions of ethanol vapor saturation, little change is observed in mesostructural ordering, (FIG. 14, panel (b)), when compared to an otherwise identically prepared sample with no initial vapor fraction of ethanol in the atmosphere (FIG. 14, panel (a)). However, as the initial partial pressure of ethanol increases, (FIG. 14, panels (c),(d)), the intensity of the diffraction spots in the 2D SAXS pattern noticeably decreases, indicating less mesostructural ordering, although the direction and degree of alignment appear to remain the same. This observation is consistent with the hypothesis that the block-copolymer/silica sol-gel precursor solution dries through solvent/cosolvent absorption and diffusion into the PDMS, as higher saturation fractions of ethanol inhibit removal of the ethanol from the PDMS, resulting in a longer drying period. One would expect that, for longer drying periods, the polymerization of the silica may occur before the mesostructural self-assembly and orientational ordering are complete, accounting for the decreased intensity of the reflections in the SAXS patterns of FIG. 14, panels (c),(d). The presence of the (110) diffraction peaks along the vertical axis of the SAXS pattern in FIG. 14, panels (c),(d) indicates lateral alignment of the silica-P123 mesostructure, as discussed in detail below.

The water and cosolvent profiles in the PDMS stamp are expected to be complicated and transient, but approaching steady-state over several (˜24) hours. For a fresh, dry PDMS stamp, the solubilities of water and ethanol are estimated to be 5.2·10⁻⁴ moles/g PDMS and 1.6·10⁻³ moles/g PDMS, respectively, as measured by the differences in the mass of a PDMS sample before and after saturation with the respective species. The diffusion coefficients of the water and ethanol can be approximated by molecular dynamical modeling, while their respective diffusivities are 1.5·10⁻⁵ cm²/s and 2.0·10⁻⁶ cm²/s, respectively. For a humid atmosphere without ethanol, water will absorb into the PDMS stamp both from the humidified atmosphere and from water in the block-copolymer/silica solution filling the microchannels. When a sufficiently thin PDMS stamp (˜1 mm) is used for a given high humidity, diffusion through the top surface of the stamp may be significant enough to affect the rate of water absorption from the microchannels, diminishing the rate of water removal, and thus slowing the rate of silica cross-linking. There are many variables affecting the rate of solvent and cosolvent removal from the block-copolymer/silica solution in the microchannels, and modeling efforts are underway to shed further investigate the timescales of the drying process.

Having shown the ability to direct the alignment of the hexagonal mesostructure perpendicular to the substrate over a large length scale, it is desirable for the mesostructured composite matrix to remain intact when the surfactant is removed. While it is advantageous to incorporate photo-responsive molecules through a one-pot synthesis during mesostructural alignment, another possible route of guest molecule incorporation may be through backfilling of the mesopore void spaces that result after surfactant removal.

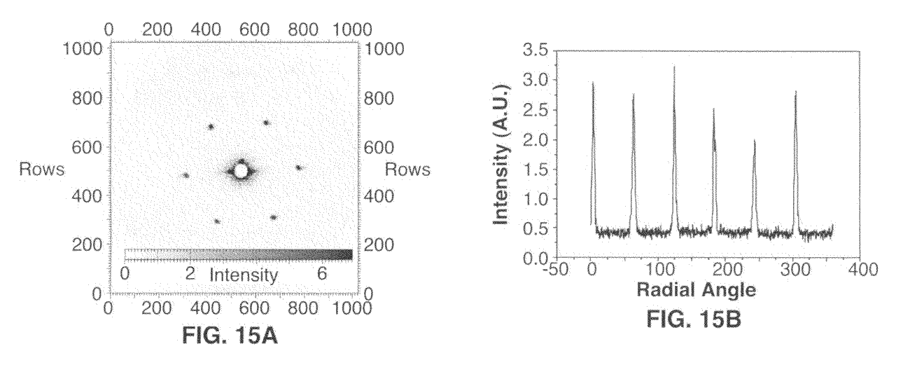

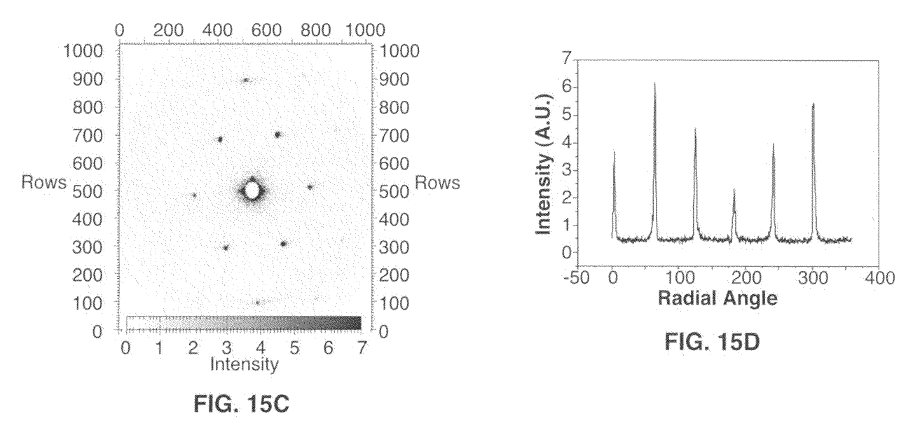

FIG. 15 shows 2D SAXS patterns for PDMS-stamped mesostructured silica films with 1 μm high×7 μm wide×15 mm long microchannels before and after calcination in air for 8 h at 500° C., as described above. FIG. 15A shows the transmission-mode 2D SAXS pattern of a hexagonally mesostructured silica-P123 film. FIG. 15B is the 2D radial integration of FIG. 15A showing narrow (˜3 degrees FWHM) reflections that confirm a high degree of alignment. FIG. 15C shows the transmission-mode 2D SAXS pattern of the same sample after calcination at 500° C. FIG. 15D is the 2D radial integration of FIG. 15C showing retention of hexagonal mesostructural ordering and high degree of alignment (˜3 degrees FWHM).

Before calcination, the 2D SAXS pattern and its radial integration in FIG. 15A and FIG. 15B show that the as-synthesized silica-P123 composite film has very high degrees of hexagonal mesostructural order and perpendicularly aligned mesochannels (˜3° FWHM), similar to that discussed previously (FIG. 6 and FIG. 12). After calcination, similar 2D SAXS and radial integration patterns were obtained (FIG. 15C and FIG. 15D), establishing that high degrees of hexagonal mesostructural order and vertical mesopore alignment (˜3° FWHM) are maintained in the patterned calcined mesoporous silica films.

(d) Lateral Alignment

For transmission-mode SAXS patterns showing no reflected intensity, such as in FIG. 13, panels (d), (e), there are several possible reasons for the lack of a diffraction pattern. These include the absence of a mesostructural order in the film due to poor or incomplete self-assembly of the block-copolymer species or the absence of a film entirely due to delaminated from the base substrate when the PDMS stamp is removed. Under certain conditions however, the absence of transmission-mode SAXS reflections also can occur for highly mesostructured films adhering to the base substrate, but whose alignments result in their (100) diffraction planes not satisfying Bragg's law. This could be the case for hexagonally mesostructured films with laterally aligned mesochannels, such as shown in FIG. 4C. Nevertheless, we have shown that one can, in this case, rotate the sample about its lateral axis to observe the (100) diffraction peaks and establish whether laterally aligned hexagonal mesostructured silica is present.

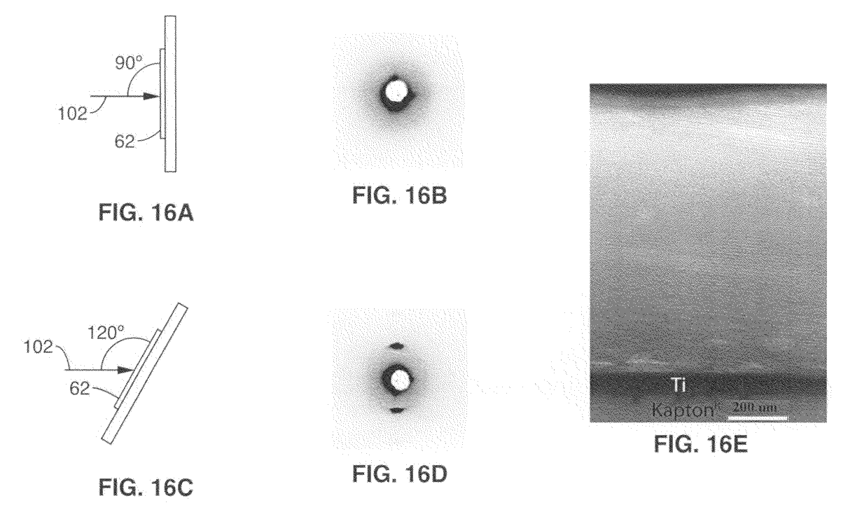

For example, refer to FIG. 16. FIG. 16A schematically illustrates the orientations of a macroscopic film and its microchannels relative to the X-ray beam in transmission-mode diffraction studies. FIG. 16B is a transmission-mode 2D SAXS pattern of mesostructured silica-P123 films with 1 μm high×7 μm wide×15 mm long microchannels formed from an ethanol/water solution patterned using a PDMS stamp under fixed relative humidity of 97% showing no apparent mesostructural order present. FIG. 16C schematically illustrates the tilted orientation of the same sample and microchannels relative to the X-ray beam in diffraction studies with the sample rotated 30-degrees about the lateral axis to show the (100) reflections from a laterally aligned hexagonal mesostructure. FIG. 16D is a 2D SAXS diffraction pattern of the same sample as in FIG. 16B showing the presence of the (100) diffraction spots from lateral alignment of the mesostructure. FIG. 16E is a cross-sectional FIB TEM image of the same sample taken parallel to the substrate, showing the highly aligned hexagonal mesostructure oriented parallel to the substrate, laterally across the 7 μm width of the microchannel.

As can be seen, FIG. 16 shows two different orientations of the same macroscopic patterned silica-P123 film with respect to the incident X-ray beam at approximately the same point, and the corresponding SAXS patterns that result. The two diffraction patterns are dramatically different. Whereas the absence of transmission-mode diffraction intensity in FIG. 16A and FIG. 16B might cause one to suspect that little or no mesostructural ordering existed, in fact, a highly aligned hexagonal mesostructure oriented laterally across the microchannels was present. This is clearly seen in the 2D SAXS pattern in FIG. 16C and FIG. 16D acquired at the same position on the same film as in FIG. 16A and FIG. 16B, but tilted 30 degrees with respect to the incident X-ray beam. A rotation angle of ˜30 degrees is necessary to show these diffraction spots, as can be predicted by considering that the hexagonal packing has six (100) diffraction planes rotated by 60 degree angles, and thus rotation by one-half of this angle will change the orientation of the hexagonal mesostructure relative to the X-ray beam.

The FIB TEM image, FIG. 16E, of the cross-section of one of the patterned microchannels confirms the presence of a high degree of mesostructural order and the alignment indicated by the SAXS patterns obtained after 30 degree sample tilting (FIG. 16C and FIG. 16D). Hexagonally mesostructured silica-P123 cylinders aligned laterally across the microchannel width are visible in the TEM image and extend across the 7 μm width. The thickness of the film, ˜825 nm, varies slightly (+/−25 nm) due to unevenness of the PDMS pattern. Interestingly, the aligned silica-P123 mesochannels tend to bend and conform to these deviations around the film surface (visible near the top of FIG. 16E), in agreement with the hypothesis of nucleation at the interface between the PDMS and the silica/P123 block-copolymer precursor solution. The presence of lateral alignment in PDMS-patterned silica-P123 mesostructured films synthesized under otherwise identical conditions as those in FIG. 6 suggests that nucleation at the corners of the patterned microchannels has two prevalent orientations for alignment: vertical to the substrate and lateral across the microchannel width. It is therefore likely that films synthesized under these conditions may contain mixed domains of vertical and laterally aligned hexagonal silica-P123 mesochannels, as discussed below.

Transmission-mode diffraction results for mesostructured films that show evidence of vertical alignments also occasionally show co-existing regions of perpendicularly and laterally oriented cylinders within the 1-mm² X-ray beam.

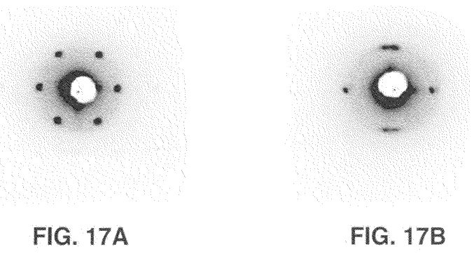

For example, refer to FIG. 17. FIG. 17A shows the transmission-mode 2D SAXS diffraction pattern that is characteristic of a hexagonal mesostructured and highly perpendicularly aligned PDMS-patterned (1 μm high×7 μm wide×15 mm long microchannels) silica-P123 film. FIG. 17B shows the 2D SAXS pattern of approximately the same location on the same sample (at the center of the film) obtained by tilting 30 degrees along the lateral axis of the film, showing the appearance of (100) diffraction peaks, which indicate the presence of co-existing laterally aligned hexagonal mesostructured regions. Whereas the transmission-mode SAXS pattern in FIG. 17A shows high extents (˜5° FWHM) of hexagonal mesostructural order and perpendicularly oriented channels, a similar pattern acquired at approximately the same spot in the same film, but tilted 30 degrees (FIG. 16C) shows reflections from hexagonal domains with different relative orientations. In FIG. 17B, the two sharp spots on the horizontal axis of the films correspond to the vertically aligned hexagonal mesostructure, while broader, twinned diffraction spots on the vertical axis correspond to laterally aligned hexagonal domains. One can obtain a rough estimate of the relative fractions of each domain by comparing the intensities of the diffraction spots when the sample is tilted 30 degrees (FIG. 16C). In the case shown here, one can roughly estimate that, within the 1 mm² area examined, roughly 60% of the sample contains well ordered and aligned silica-P123 mesochannels oriented vertically relative to the substrate, with the remaining 40% oriented laterally across the microchannel width. However, these fractions have shown large variance between identically prepared samples, including as low as 0% lateral alignment. From this SAXS pattern, one cannot rule out the possible presence of a longitudinally oriented fraction, as the diffraction spots coincide with the six-spot pattern of a vertically aligned hexagonal mesostructure. However, by comparing the six diffraction spots in transmission-mode SAXS (FIG. 17A), one can estimate by the approximately equal spot intensities that the presence of longitudinal alignment is not significant. Likewise, isotropically oriented domains do not appear here, as a ring pattern would be visible, independent of sample orientation in the X-ray beam. The variables that govern selection of one type of alignment over the other remain under investigation, but are suspected to involve variations in solvent and cosolvent fluxes. In particular, absorption of solvent into the lateral edges of the microchannels may have value in determining between the two most prevalent directions of alignment (lateral and vertical). Theoretical modeling of these mass-transfer phenomena is expected to elucidate the relative significances of lateral, vertical, and longitudinal fluxes of the solvent and cosolvent species at the points at which initial mesostructure nucleation occurs

(e) Longitudinal Alignment

Similar to the methods used to produce and characterize vertically and laterally aligned patterned, hexagonal mesostructured silica films, it may also be desirable to achieve longitudinal alignment of the mesochannels across the macroscopic length scales of the microchannel pattern. Previous results have confirmed the hypothesis that a high degree of orientational order and alignment of the hexagonal silica-P123 mesochannels can be obtained by influencing the solvent and cosolvent fluxes out of the silica-P123 triblock-copolymer precursor solution. These controlled fluxes result in control over where the hexagonal silica-P123 mesostructure nucleates and the direction that they propagate. It is thought that by changing the location of nucleation, it will be possible to change the thermodynamic effects that govern the direction of orientational ordering of the hexagonal mesostructure to induce longitudinal alignment. This alignment is desired for possible applications in membranes, as well as to illustrate how control over the mesostructure nucleation location can control the direction of alignment.

It is thought that these principles can also be used to form well ordered mesochannels that are oriented longitudinally down the microchannel axes by directing the solvent flux out the ends of the microchannels where they are exposed to the atmosphere. By promoting evaporation at the ends of the microchannels rather than by absorption into the PDMS stamp, the nucleation of the hexagonal mesostructure may occur at the interface between the atmosphere and the silica/P123 block-copolymer precursor sol. At this interface, the hydrophobic PPO moieties of the triblock-copolymer are expected to be preferentially distributed at the relatively hydrophobic air interface, from which the hexagonal mesochannels grow longitudinally along a microchannel axis.

The hypothesis that longitudinally aligned hexagonal mesophases can be controllably obtained was tested by enhancing the rate of solvent removal from open microchannel ends vis-à-vis diffusion into the PDMS stamp. This was achieved by saturating the PDMS with ethanol prior to preparing the stamped patterned film (FIG. 2A), so that the solvent removal occurred preferentially along the longitudinal axes of the microchannels and out their ends, which were exposed to the surrounding atmosphere. When triblock copolymer silica precursor sols were placed on a metalized substrate and an ethanol-saturated PDMS stamp with approximate thickness of 5 mm (with the ends of the 1 μm×˜7 μm microchannels exposed to the atmosphere and the longitudinal axes reduced to 7 mm in length) was used to direct the film patterning, a hexagonal silica mesostructure formed and was aligned predominantly along the longitudinal microchannel axes. The mesostructural alignment of the patterned silica-P123 film was characterized by transmission-mode SAXS diffraction and cross-sectional TEM measurements, as described above.

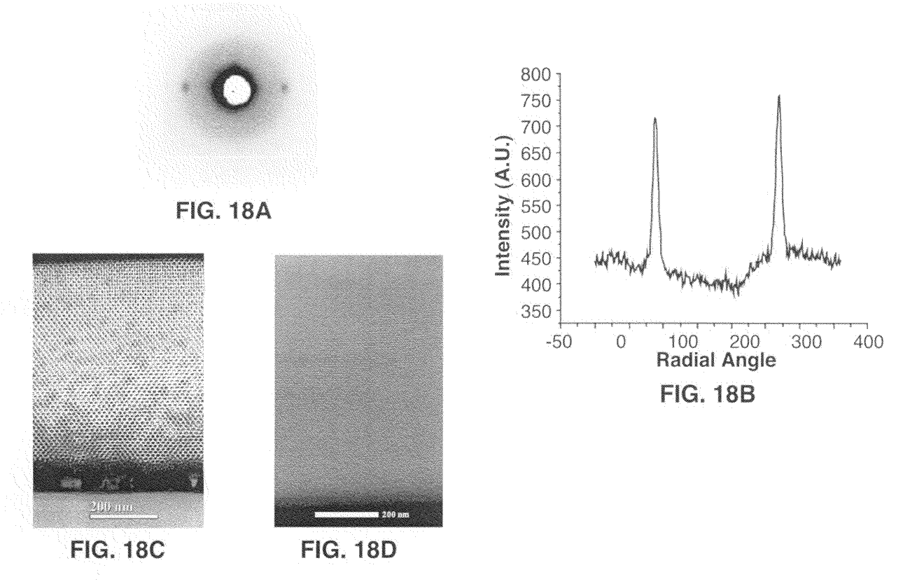

For example, refer to FIG. 18. FIG. 18A shows a 2D SAXS pattern of a hexagonally mesostructured silica-P123 film formed using a patterned PDMS stamp with 1 μm high×7 μm wide×7 mm long microchannels that was saturated in ethanol. FIG. 18B shows the 2D radial integration of the SAXS pattern in FIG. 18A showing a high degree of alignment (˜10 degrees FWHM). FIG. 18C shows a FIB TEM micrograph of the same sample showing a cross-sectional image of the center portion of a single microchannel on a aluminum/Kapton® substrate, approximately 3 mm from the sol-gel precursor solution/air interface, confirming the high degree of longitudinal alignment indicated by (FIG. 18A, B). FIG. 18D is a TEM image of a similar sample, except formed on a titanium-coated Kapton® substrate, with the FIB cut made along the longitudinal axis of the microchannel to show the longitudinal alignment along the microchannel axis.

FIG. 18A shows a sharp diffraction pattern (d-spacing of 11.8 nm) that is characteristic of a hexagonal mesostructure with the PPO cylinders oriented perpendicular to the beam path and longitudinally down the microchannel axes (FIG. 4D). The 2D radially integrated transmission-mode SAXS pattern (FIG. 18B) similarly indicates a high degree of alignment (˜10 degrees FWHM) over the macroscopic length scale of the X-ray beam width, although less than that observed for films with perpendicular alignment.

It is hypothesized, based on the low intensity of the diffraction spots, that the saturation of the PDMS stamp inhibits the rate of solvent and cosolvent removal from the silica/P123 block-copolymer precursor solution enough to disrupt mesostructural ordering. Without such ordering, of course, mesoscale alignment does not develop. The low intensity of the diffraction spots could also indicate the presence of a mix of longitudinal and lateral alignment with forbidden X-ray reflections (as previously discussed). TEM samples showing the presence of no mesostructural ordering in the microchannel make this the less likely of the two hypotheses. The TEM micrographs in FIG. 18C and FIG. 18D, taken along a single microchannel axis, show a high degree of longitudinal alignment parallel to the substrate, with the anisotropic axes of the hexagonally arrayed mesochannels extending into the plane of the image. As for the perpendicularly oriented hexagonal mesostructured silica-P123 films (FIG. 6B and FIG. 6C), the high degree of alignment is maintained across the entire film thickness of approximately 600 nm, as well as the entire width of the microchannel. Once again, the alignment shows independence of the metal used to form a smooth surface.

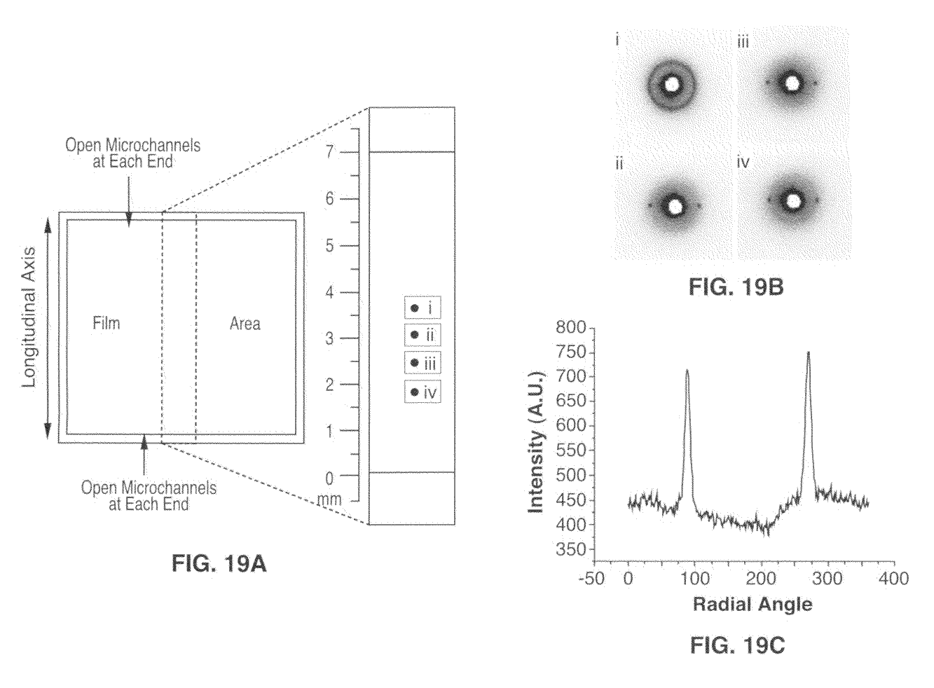

Referring to FIG. 19, to characterize the degree of mesostructural alignment across macroscopic length scales of the patterned films, SAXS measurements were made at several points along longitudinal axes of the microchannels, while keeping the sample position along the lateral axis fixed. FIG. 19A shows the different locations where the 2D SAXS patterns were acquired along the 1 μm high×7 μm wide×7 mm long microchannels of a PDMS-patterned, hexagonally mesostructured silica-P123 film; FIG. 19B shows 2D SAXS patterns taken from locations i-iv, as indicated in FIG. 19A. FIG. 19C is a 2D radial integration showing the high degree of alignment of SAXS pattern ii.

The diffraction patterns shown in FIG. 19B indicate that high degrees of longitudinally aligned hexagonal mesostructured domains (within an ensemble of microchannels) are maintained at least 3 mm away from the microchannel ends. The degree of alignment decreases toward the stamp center for the film shown, eventually exhibiting hexagonal order, but for an apparently isotropic distribution of domain orientations (FIG. 19B, panel i).

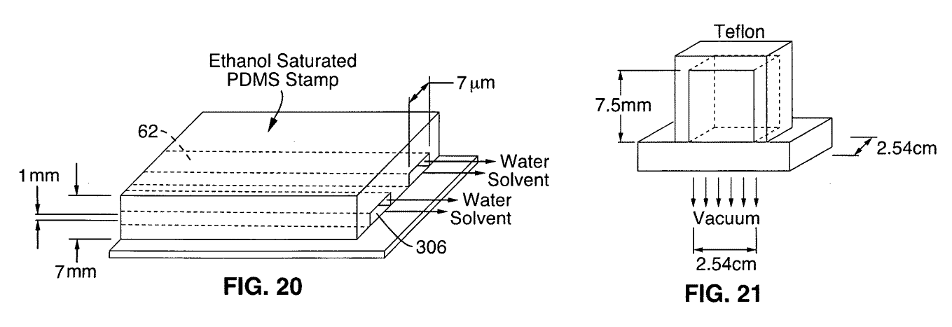

The longitudinal alignment is explained by and consistent with the solvent being removed from the block-copolymer/silica precursor sol by evaporation out the open ends 306 of the stamp microchannels across a boundary perpendicular to the stamp, shown in FIG. 20. With the solvent flux into the PDMS inhibited due to saturation (before the stamp was applied to the silica-P123 precursor solution (FIG. 2A), solvent removal occurs principally at the microchannel/air interface at open ends 306, where mesostructure nucleation occurs. Because the free air interface is relatively hydrophobic, the hexagonal mesostructure tends to favor contact between the PPO cylinder ends that produce domain growth and alignment normal to the air interface and thus parallel to the substrate. Channel dimensions have not been drawn to scale.

According to this drying protocol, one would expect that as the distance from the microchannel ends toward the PDMS stamp center increases, a greater fraction of the solvent may be removed perpendicularly by diffusion into and through the stamp. Farther away from the stamp edges, the rate of solvent/cosolvent removal by evaporation out the ends of the microchannels may become comparable to the rates of solvent absorption and diffusion into the PDMS stamp. In such a case, mesostructure nucleation and growth may occur at interfaces and directions that lead to a distribution of domain orientations, resulting in a ring diffraction pattern.

Interestingly, in mesostructured silica-P123 films prepared at 33% relative humidity using thin (˜1 mm) unsaturated PDMS stamps, 2D SAXS measurements in FIG. 13, panel (e) reveal the presence of weak mesostructural ordering and alignment along the longitudinal axis. The intensity of this SAXS pattern is significantly weaker than those of vertically aligned silica-P123 hexagonal mesostructures associated with the SAXS pattern in FIG. 13, panels (a), (b), suggesting significantly less orientational order. The cause of this is not currently known, but modeling efforts are underway to shed more light on the interrelationships among the various coupled and transient diffusion and self-assembly processes. Consistency and predictive capabilities for corroborating results obtained for different PDMS stamp thicknesses, degrees of solvent/cosolvent saturation, etc. are expected to be possible.

### Conclusions

By controlling the rates and directions of the removal of solvent species during drying of the block-copolymer/silica precursor sol, micropatterned silica films have been synthesized with hexagonal mesostructures having different relative alignments. These include hexagonal silica-P123 mesophases where the hydrophobic PPO cylinders in the microchannels are aligned perpendicular to the metalized lower substrate, or parallel to the substrate and laterally or longitudinally oriented with respect to the axes of patterned microchannels.

The hexagonal mesostructure is formed during drying of the block-copolymer/silica precursor sol. As the relative concentration of the block-copolymer species increases, micelles begin to form. Eventually, these micelles self-assemble and the hexagonal (or other liquid-crystal-like) mesostructure first nucleates. By controlling the location of this nucleation, it is possible to affect the direction of propagation of the hexagonal cylinders (or other anisotropic liquid-crystal-like structures), leading to an aligned mesostructure. After self-assembly of the triblock-copolymer occurs, the silica then cross-links, forming an inorganic-organic mesostructured film. By selecting conditions so that the self-assembly takes place while silica polymerization kinetics are slow (low pH (e.g., ˜1.75) and/or low temperature), the mesostructure can form before extensive silica cross-linking occurs. The low pH, however, can corrode the metalized substrates used to provide a smooth surface for film growth. Some metals are resistant to the acidic conditions present during the self-assembly process, as shown in Pourbaix diagrams, FIG. 7, which guide the selection of the substrate metal for the pH and processing conditions used.

Vertical and lateral directions of alignment occur when a dry PDMS stamp is placed over the block-copolymer/silica precursor sol. Drying of the sol occurs as the solvent and cosolvent species absorb and diffuse through the stamp, resulting in initial nucleation of mesostructure domains at the corners of the microchannels. If the relatively hydrophobic PPO blocks preferentially interact with the relatively hydrophobic top PDMS surface of the stamp microchannel, the mesostructure will tend to propagate perpendicular to the substrate, resulting in vertically aligned silica/P123 hexagonal mesostructure domains. If the PPO blocks preferentially interact with the PDMS side wall of the stamp microchannel, the mesostructure will tend to propagate parallel to the substrate across the microchannel width. Among the variables that govern such nucleation and anisotropic growth processes, the rates and directions of solvent/cosolvent removal into the PDMS stamp or evaporating from sol-air interfaces appear to be valuable for establishing the direction of mesostructure alignment.

Longitudinal alignment occurs through a similar process of solvent removal, mesostructure nucleation and growth, followed by silica polymerization. The principal difference is that the solvent and cosolvent species are removed predominantly by evaporation at the ends of the exposed microchannels, where there are air interfaces with the silica/block-copolymer precursor sol. The solvent is inhibited from absorption and diffusion through the PDMS by saturating the stamp in ethanol before its use to micromold ca. 11 μL of the precursor sol (FIG. 2A). We believe that nucleation occurs at the microchannel/air interface, where the PPO domains of the P123 preferentially align with the relatively hydrophobic air, directing propagation of the hexagonal mesostructure down the longitudinal axis of the microchannel.

The development of anisotropic growth and alignment from the original nucleation sites or interfaces is useful for producing uniform orientational order in 3D monoliths. The principles of directed solvent removal may applied to thick free-standing films, monoliths, and fibers to develop long-range mesostructurally and orientationally ordered solids with anisotropic bulk properties that would be useful in separations, catalysis, sensor, or optics applications. In an attempt to form such a P123/silica monolith with a highly aligned hexagonal mesostructure, a THF-based silica/block-copolymer precursor sol was prepared and poured into a Teflon® mold and covered with a patterned-PDMS stamp illustrated schematically in FIG. 21. To enhance the mass transfer of the solvent and co-solvent out of the THF-based silica/block copolymer precursor solution, the non-patterned side of the PDMS stamp was exposed to a vacuum line. We believe that the vacuum will improve the flux of the solvent and cosolvent species through the PDMS, allowing for more rapid self-assembly of the P123 before polymerization of the silica. In preliminary results, a 3D silica-P123 monolith formed, but was not stable after removal from the mold, preventing SAXS characterization of its mesostructural ordering and alignment. The lack of stability was attributed to stress formed in the monolith from shrinking during the drying process. To rectify this, the depth of the Teflon® mold can be cut in half to the dimensions shown in FIG. 21.

Other materials may be suitable to use as stamps for soft-lithographic patterning. For example, fluorosilicone resins could potentially be cured into a similar stamp as that of the PDMS. Fluorosilicone resins often exhibit low solubilities for absorbing solvent species and so may be good candidates for promoting solvent removal out the ends of the patterned microchannels, instead of through the stamp itself.

A desirable stamp criterion is that the silica mesostructure should not adhere strongly to the stamp material, so that it remains on the lower substrate when the stamp is removed. Also, the material should be sufficiently flexible that when the stamp is pressed down over the block-copolymer/silica solution it promotes even wetting of the substrate, while simultaneously sealing tightly to the substrate to confine the solution within the microchannels. Lastly, the material should be sufficiently rigid to be patternable and permit microchannel arrays to be stamped/molded without significant mechanical deformation across or along the microchannel dimensions.

By simulation of various PDMS stamps (or stamps from other materials) with different macroscopic and/or microchannel configurations, different solvent solubilities and diffusivities and in different controlled atmospheres, it is anticipated that optimum compositions and processing conditions can be estimated for generating macroscopic alignment of diverse inorganic organic mesostructured materials. The combination of close feedback among synthesis, processing, characterization and modeling results are expected to improve material properties, broaden their ranges of properties, and assist with their integration into new processes and devices.

### Example

### Incorporation of Photo-Responsive Species

The general method for preparing aligned mesostructural composites involves the creation of a patterned PDMS stamp to be used as a mold for directing the patterning or form of mesostructured silica/P123 as it forms from a block-copolymer sol-gel precursor solution on a substrate. The drying period extends over a period of 6-7 days under fixed environmental conditions that control the rate(s) of solvent/co-solvent species removal from the precursor solution. After the drying period, the PDMS stamp is removed, leaving the patterned mesostructured material on the substrate for characterization by SAXS, and cross-sectional TEM.

### Materials and Methods

Four-inch silicon [100] wafers (Wafer World Inc., West Palm Beach, Fla.), were patterned by photolithography and subsequently used as a master replica from which patterned micromold PDMS stamps were prepared. The master pattern was formed by spin-coating photoresist AZ5214, developed according to a desired pattern, followed by 6 s etch cycles for a total of 30-36 s. After coating the silicon wafer with 1H,1H,2H,2H-perfluoro-decyltricholorosilane to prevent significant adhesion of the PDMS to the silicon surface, a mixture of Sylgard® 184 elastomer and a dimethyl-methylhydrogen siloxane curing agent in a 10:1 ratio was poured on top of the patterned silicon master and cured overnight at 65° C. under vacuum. The pattern imprinted onto the PDMS stamp was comprised of long microchannels 1.5 cm in length, 1 μm in height, and 5, 7, or 12 μm in width. The thickness of the stamps above the channels was controlled by adjusting the amount of elastomer poured on top of the patterned silicon master.

Thin metalized Kapton® was used as a substrate for the films, providing a smooth surface for film deposition. The Kapton® support is transparent to X-rays and allows for efficient characterization of the mesostructured silica by transmission-mode SAXS. Substrates for the films were prepared by depositing titanium metal via physical vapor deposition methods using an electron beam evaporator and a 99.999% titanium source. Titanium metal was chosen because of its excellent corrosion resistance under the acidic conditions of the synthesis. The titanium was deposited onto a 0.05 inch thick Kapton® support (DE350—Dunmore Corporation, Bristol, Pa.) or a thin borosilicate glass slide. The glass slide was used when calcination was performed to remove the structure-directing triblock copolymer surfactant species at temperatures at which the Kapton® would not withstand.

Amphiphilic surfactant species were used to direct the formation of mesostructured silica. Soluble hydrophilic silica precursor species were prepared by first hydrolyzing tetraethoxysilane, (TEOS, Aldrich Chemicals) in an acidic, ethanol-based solution for one hour at room temperature. A second solution was prepared by dissolving poly(ethylene oxide)-poly(propylene oxide)-poly(ethylene oxide) (EO₂₀PO₇₀EO₂₀, Pluronic P123, BASF, Mount Olive, N.J.) triblock copolymer species in ethanol, which was stirred at room temperature for one hour. This solution was then added to a small mass of tetrakis (p-sulfonatophenyl) porphyrin dye (TPPS₄). The two solutions were mixed under stirring for an additional hour at room temperature, yielding an overall mixture for a typical synthesis with a composition (molar ratios) of 1.0 TEOS:0.017 P123:22.15 EtOH:0.02HCl:5.00H₂O:0.019 TPPS₄. This solution was then placed on a metalized (typically titanium, due to the metal's stability under acidic conditions) substrate, after which the patterned PDMS stamp (thickness ˜1 mm) was placed on top of the precursor solution and pressure applied in such a manner that the entire stamp area was wetted. The solution was allowed to dry over a period of several days to 1 week in a fixed volume chamber (2.4 L in volume) maintained at 25° C. at 97% relative humidity through a saturated salt solution of K₂SO₄. After drying, the PDMS stamp was carefully removed by scoring at the film edge with a razor blade at one edge of the stamp and slowly peeling the PDMS away from the substrate, leaving the patterned, mesostructured silica/P123/TPPS₄ composite adhering to the substrate surface.

Similar patterned mesostructured silica/P123 films containing conjugated polymer guest species were prepared by using the more hydrophobic solvent tetrahydrofuran (THF). In this case, tetraethoxysilane, (TEOS, Aldrich Chemicals) was hydrolyzed in an acidic, tetrahydrofuran-based solution for one hour and then mixed with a solution of EO₂₀PO₇₀EO₂₀ (Pluronic P123, BASF, Mount Olive, N.J.) triblock copolymer species also dissolved in tetrahydrofuran. In a typical synthesis, 1.17 mL of THF, 0.23 mL of TEOS, and 0.09 mL of 0.07 M HCl were mixed at room temperature in a small vial, then added to 0.09 g of Pluronic® P123 to dissolve the surfactant, followed by the addition of another 2.2 mL of THF containing 0.20-3.8 mg/mL of the semiconducting polymer poly(9,9-dioctylfluorine) (PF8). As above, the precursor solution was placed on a metalized (typically titanium) substrate, the patterned PDMS stamp (thickness ˜8 mm) was placed on top of the precursor sol, and pressure was applied so the entire stamp area was wetted. The solution was allowed to dry over a period of 2 days in a fixed volume chamber (2.4 L in volume) maintained at 53% relative humidity through a saturated salt solution of NaBr, after which the stamp was removed as described above.

Small-angle X-ray scattering (SAXS) measurements were conducted using an Ultra-SAXS diffractometer with a copper anode (λ=1.54 Å) and a two-dimensional (2D) image plate with a sample-to-detector distance of 1.725 m. An intermediate-SAXS (i-SAXS) diffractometer was also used with similar features, but a sample-to-detector distance of 0.758 m.

Fluorescence measurements were made using a Perkin Elmer LS 55 Luminescence Spectrometer with excitation at 380 nm for the PF8 semiconducting polymer and 275-325 nm for the conjugated oligomers. Slit widths of 5 nm were used along with a 1% attenuation filter, and multiple-scan (typically 5 scans) averaging to improve the signal-to-noise ratio. Fluorescent micrographs were acquired using an Olympus BX41 optical microscope with a LUCPLFLN 20× objective with an ultra-violet excitation mirror unit providing excitation in the range of 330-385 nm with a 420 nm emission filter.

Polarized optical light microscopy images were obtained using a Nikon Optiphot-2 optical microscope with cross-polarizing accessories. The films were mounted to a glass slide and fixed upright on a movable stage in such a manner that the microchannels of the patterned film were parallel to that of the incident light path. To show birefringent properties, the sample stage was rotated in a plane perpendicular to the light path.

In some cases, the structure-directing surfactant species were removed from the mesostructured material through solvent extraction by refluxing in ethanol for 2 days at 100° C. This was followed by washing in deionized water over night at 80° C., and then drying in an oven for 8 h at 100° C. The films were then re-characterized by SAXS to show the preservation of mesostructural order and alignment and determine any changes d-spacing.

In some studies, cubic SBA-16 mesostructured silica was used to test grafting of n-butyltrichlorosilane onto the mesopore surfaces after surfactant removal. The cubic SBA-16 mesostructured silica was synthesized hydrothermally by dissolving 4.0 g of Pluronic® F127 (EO₁₀₆PO₇₀EO₁₀₆, BASF, Mount Olive, N.J.) in 30 g of deionized water with 120 g of 2 M HCl and stirring at room temperature for 20 min. 8.5 g of TEOS were added followed by an additional 20 min of stirring. The solution was then sealed and aged at 80° C. for 2 days.

To promote the backfilling of hydrophobic optical guest species into the mesopores, the pore walls were hydrophobically functionalized with n-butyltrichlorosilane after removal of the surfactant species. Typically, the mesoporous material was placed in a sealed 1 L HDPE chamber (under an Ar environment) containing 200 μL of the functionalizing molecule (in liquid form). The chamber was then sealed and heated to 65° C. for 24 h. To characterize the efficacy of n-butyltrichlorosilane grafting onto the pore walls, NMR measurements were conducted to analyze the fraction of Q², Q³, and Q⁴ silica species before and after the grafting procedure. Solid-state NMR measurements were made using a Bruker AVANCE-500 wide bore spectrometer (11.7 T) operating at 99.3 MHz for ²⁹Si. The sample was loaded into a 4 mm rotor by packing approximately 100 mg of the SBA-16 powder on either side of a 3 mg piece of cross-linked PDMS, which served as an internal chemical shift and spin-counting standard. ²⁹Si NMR spectra were acquired under magical-angle-spinning conditions of 10 kHz at room temperature.

### Results and Discussion

The incorporation of co-self-assembled and aligned guest species in orientationally ordered mesostructured silica films is expected to be general, provided that the aspect ratios and solubilities of the guests, e.g., supramolecular aggregates, macromolecules, nanoparticles, etc., are compatible with and conform to the mesochannel dimensions and components. One example is the inclusion of supramolecular porphyrin J-aggregates in aligned, hexagonally mesostructured silica, both of which form under mutually compatible, strongly acidic conditions. Based on separate recent results, the porphyrin species were hypothesized to become incorporated into the surfactant during the formation of the mesostructure, resulting in J-aggregated TPPS₄ molecules that will yield desired anisotropic optical properties. Specifically, TPPS₄ porphyrin dye species were introduced into orientationally ordered mesostructured silica films at low dye weight loading (˜1 wt %) to ensure solubility in the hydrophobic (PPO) channels and minimal disruption of the hexagonal mesostructural order. Higher TPPS₄ loadings or longer drying periods resulted in the porphyrin molecules phase separating and disrupting mesostructural alignment. Due to the small scale of the anisotropic dimension of such films, the characterization of anisotropic optical properties is difficult. Polarized Optical Microscopy (POM) can be a useful tool for distinguishing between isotropic and anisotropic materials, including aligned mesostructured silica films containing J-aggregated porphyrins, based on the observance of birefringence behavior.

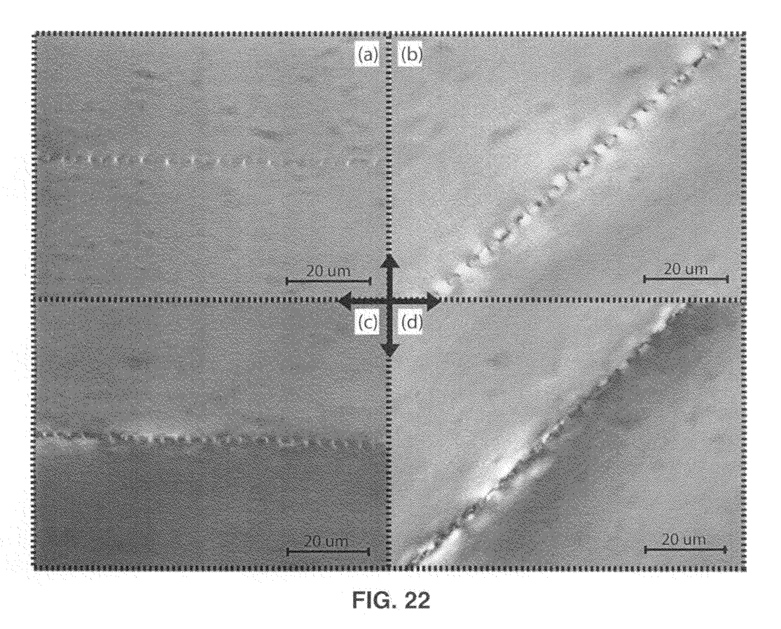

FIG. 22 shows polarized optical micrographs of patterned P123-silica mesostructured films formed from a precursor sol containing 1 wt % TPPS4 porphyrin dye (a) with an aligned mesostructure, with the vertical axis of the film parallel to one polarizer; (b) with an aligned mesostructure, with the vertical axis of the film 45 degrees to both polarizers; (c) without mesostructural alignment, with the vertical axis of the film parallel to one polarizer; (d) without mesostructural alignment, with the vertical axis of the film 45 degrees to both polarizers. The arrows represent the direction of polarization of the incident light.

In POM, one expects extinction (no light transmission) when the anisotropic axis of a birefringent material is aligned parallel to one of the cross-polarizers, and maximum light transmission when the anisotropic axis is at 45 degrees between the two polarizers. When the anisotropic axis of the aligned mesostructured silica composite film (as established through 2D SAXS diffraction measurements to determine the mean direction of alignment) is parallel with one of the two crossed polarizers, FIG. 22(a),(c), very little light is transmitted. This behavior is due to the birefringent nature of the nanocomposite material diffracting the polarized incident light into two separate components parallel and perpendicular to the anisotropic axis of the film, resulting in a minimum amount of light that can pass through the second polarizer.

The small amount of residual light that is visible in the background of FIG. 22(a) is due to imperfect alignment of the polarizers, and the small areas of apparently highly intense light in FIG. 22(d) are likely due to defects created by handling during sample mounting. However, when the anisotropic axis of the aligned mesostructured silica composite film is placed 45 degrees to both polarizers, FIG. 22(b), the greatest intensity of transmitted light occurs as the polarized incident light is diffracted so that a maximum amount of light can pass through the second polarizer. This behavior is characteristic of a birefringent material. As such, otherwise identical porphyrin-containing mesostructured silica films that differ in their extents of long-range orientational ordering can be distinguished by the intensity of light transmitted in polarized optical micrographs. For example, The POM image in FIG. 22(b) shows very intense and uniform light transmission from regions corresponding to a hexagonally aligned mesostructured silica film prepared with a high degree of vertical mesoscopic alignment and containing occluded porphyrin J-aggregates. By comparison, significantly less light intensity is observed in FIG. 22(d) under otherwise identical conditions from a hexagonally mesostructured silica film containing porphyrin J-aggregates, but without an aligned mesostructure. Although both films contain 1 wt % porphyrin, the intensity of light from the aligned sample is higher. This is attributed to the alignment of the silica mesostructure inducing alignment of the porphyrin J-aggregates, compared to the unaligned film in which the porphyrin J-aggregates are expected to be oriented isotropically, including (in some regions) parallel to a polarizer. One also expects a small degree of anisotropic behavior to come from the alignment of the hexagonal matrix itself, regardless of the alignment of the porphyrin guest species. These results indicate that during the self-assembly and alignment of the mesostructured silica host, the photo-responsive guest molecules are co-assembled within the silica mesochannels, with alignment imparted to the anisotropic axes of the guest molecule aggregates.

A second example of co-assembly and alignment of guest species in hexagonally and orientationally ordered mesostructured silica is the incorporation of conjugated polymer species in patterned films. In such systems, care should especially be taken to select synthesis mixture compositions and conditions to maintain the mutual solubilities of the highly hydrophobic conjugated polymer guest and mesostructure-directing block copolymer species. In the case of Pluronic®-type block copolymers, tetrahydrofuran is an excellent solvent for both EOₓ and PO_{y} blocks, as well as many conjugated polymers. In addition to promoting the solubilities of hydrophobic guest species, THF-based sols dry much faster, providing less time for the guest molecules to macroscopically phase-separate, as the mesostructure-directing Pluronic® triblock copolymers self-assemble and the silica cross-links and solidifies. Previous syntheses that sought to include photo-responsive guest molecules, specifically J-aggregated porphyrin dyes, in polar, ethanol-based silica sols showed such phase separation to be a major challenge.

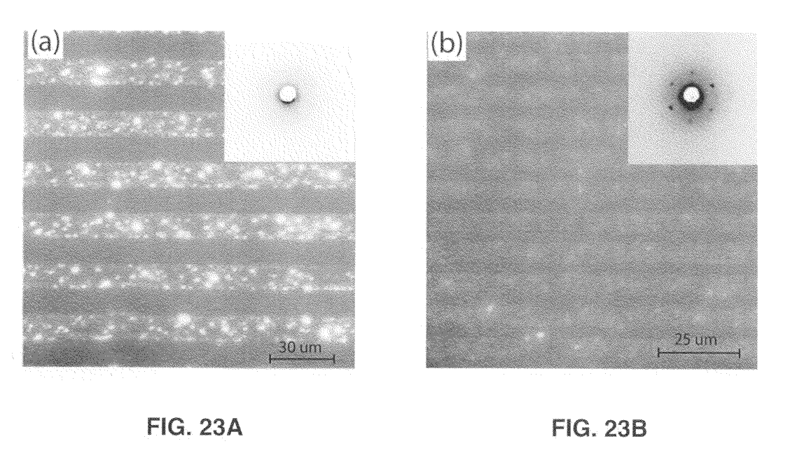

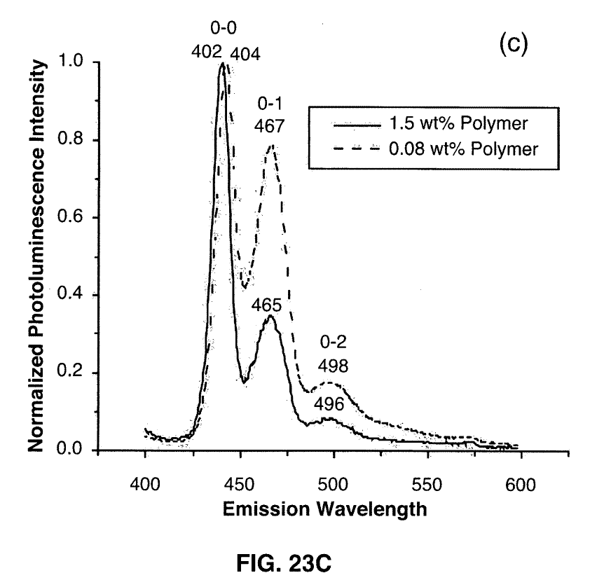

FIG. 23 shows preliminary results aimed at incorporating semiconducting polymer species into the patterned and aligned silica mesostructures. Fluorescence microscope images of patterned mesostructured P123-silica films (approximately 600 nm thickness) formed by incorporation of semiconducting poly(9,9-dioctylfluorine) (PF8) polymer species from a THF-based silica sol with approximately 1.5 wt % PF8 and 0.08 wt % PF8 are shown in FIG. 23A and FIG. 23B, respectively. The insets show transmission-mode SAXS diffraction patterns from approximately the same part of the film areas as the respective photos. FIG. 23C shows normalized photoluminescence spectra of the two films with excitation at 380 nm.

More specifically, FIG. 23A and FIG. 23B show fluorescence micrographs of two patterned mesostructured P123-silica films with different weight loadings of semiconducting polymer PF8 species that are strongly blue-emitting after excitation with near-UV light. Large aggregates of PF8 that are several microns wide are visible, particularly at the higher loading of 1.5 wt % (FIG. 23A). This suggests that macro-phase separation of the polymer occurred, leading to aggregates that are not incorporated nor aligned within the mesostructured silica host matrix. Based on the lack of a clear diffraction pattern in the inset to FIG. 23A, there is further indication that for 1.5 wt % PF8, phase separation disrupts the mesostructural ordering in the film. The photoluminescence spectrum in FIG. 23C of the film formed with 1.5 wt % PF8 has a relatively strong 0-1 emission band at 465 nm relative to that of the 0-0 emission band (the most intense band) at 442 nm, which is characteristic of aggregated PF8 polymer species. The 0-2 emission band at 496 nm is also clearly visible. The fluorescence micrograph, in FIG. 23B, for an otherwise identically patterned and mesostructured P123-silica film containing 0.08 wt % PF8 also shows microchannels that are clearly illuminated by the emission of the semiconducting polymer. However, consistent with the significantly smaller weight loading of the PF8, less evidence of macroscopic phase-separation is observed. With such reduced phase segregation, self-assembly of a hexagonal P123-silica mesostructure occurred by controlling solvent removal into the PDMS stamp (see discussion in the previous section above), as characterized by the 6-spot transmission-mode SAXS pattern indicative of a highly vertically aligned hexagonal mesostructure, FIG. 23B inset. In addition, the photoluminescence spectrum in FIG. 23C that is blue-shifted 3 nm, due to a decrease in effective conjugation length, shows a 0-1 emission band that is much less intense than that of the 0-0 band at 442 nm, also consistent with reduced inhomogeneous aggregation.

Because not all guest molecules are compatible with the synthesis conditions required to incorporate them by co-assembly in a “one-pot” method, it is desirable to show that backfilling of oriented mesopores is also possible. To do so, following otherwise identical PDMS patterning, mesostructure self-assembly, alignment, and silica cross-linking (as described in the previous section above), the P123 surfactant species were removed prior to introducing the photo-responsive guest species. Solvent extraction at 100° C. in ethanol was used to remove the soluble triblock copolymer species, while preventing additional cross-linking of the silica network and thereby retaining silanol sites for grafting functionalizing agents onto the pore walls. For example, grafting of alkylsiloxanes can subsequently be used to impart favorable hydrophobicity to the pore wall surfaces, which interact favorably with hydrophobic organic guest molecules, including many photo-responsive species.

To examine the efficacy of surface grafting strategies, a powder sample of cubic SBA-16 mesoporous silica was synthesized, functionalized, and characterized by NMR. Following solvent extraction of the structure-directing triblock copolymer species and subsequent drying of the SBA-16 powder, n-butyltrichlorosilane was grafted onto the interior silica mesopore surfaces by using a vapor deposition method as described in experimental methods.

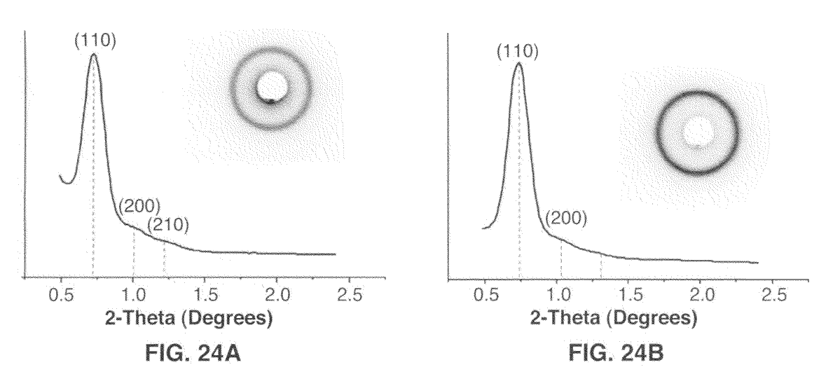

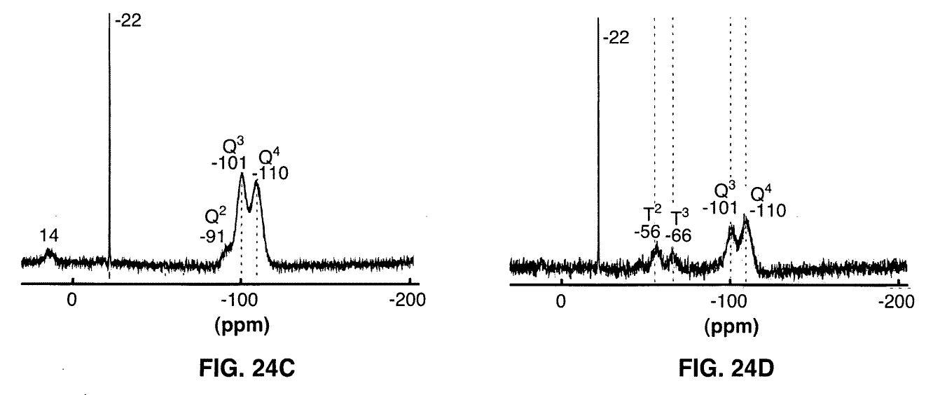

FIG. 24A and FIG. 24B show azimuthal integration of SAXS diffraction patterns of mesostructured SBA-16 powders. FIG. 24A corresponds to as-synthesized F127-silca and FIG. 24B is after removal of the F127 species by solvent extraction. The insets are 2D diffraction patterns. FIG. 24C and FIG. 24D show solid-state single-pulse 1D ²⁹Si MAS NMR spectra, with FIG. 24C being the same solvent-extracted silica powder in FIG. 24B and FIG. 24D being after functionalization with n-butyltrichlorosilane. The ²⁹Si NMR measurements were conducted at room temperature under MAS conditions at 10 kHz.

The SAXS diffraction patterns, shown in FIG. 24, of the as-synthesized and solvent-extracted SBA-16 powders are consistent with cubic mesostructural ordering before and after removal of the block copolymer species. The F127 block copolymer species was used here instead of P123 in order to more easily obtain a cubic mesostructure with a much higher surface area than the hexagonal phase. In the as-synthesized powder, the dominant reflection with a d-spacing of 12.4 nm can be indexed to the (110) reflection of the cubic lm3m structure, along with the poorly resolved (200) and (210) reflections corresponding to d-spacings of 9.4 nm and 7.2 nm, respectively, confirms the presence of the cubic mesostructure.

In the solvent-extracted silica, only the dominant (110) reflection (d-spacing of 11.2 nm) and a poorly resolved (200) reflection (d-spacing of 7.9 nm) are present. The low resolution of the higher order reflections indicates relatively poor long-range mesostructural ordering. The solvent-extracted powder was subjected to a vapor-grafting procedure by which n-butyltrichlorosilane species reacted with surface silanol species to become covalently bonded to the mesopore surfaces. Single-pulse 1D ²⁹Si MAS NMR measurements were conducted to confirm the formation of T² and T³ sites, indicating the presence of grafted organosiloxane moieties onto the silica framework. The very narrow and intense ²⁹Si peak at −22 ppm is from PDMS added as an internal chemical shift and spin-counting standard, which was used to quantify the ²⁹Si peak intensities and associated species populations before and after functionalization. The weak and broader peak at 14 ppm in both spectra is from the PDMS standard as well, likely from sites of incomplete cross-linking. The ²⁹Si MAS spectrum shown in FIG. 24C of the pre-functionalized mesoporous powder indicates that the silica mesostructure is incompletely cross-linked, as a large fraction (approximately 56%) of the silica is made of up Q³ sites, with one silanol group available for reaction with the n-butyltricholorosilane species (although not necessarily at an accessible location on the mesopore surface). An additional 4% of the mesostructure is made up of Q² sites, with the remaining 40% as fully cross-linked Q⁴ moieties. Overall, the ratio of Q² and Q³ sites to Q⁴ sites is approximately 1.48:1. After functionalization, T² sites at −56 ppm and T³ sites at −66 ppm are present in the spectrum in FIG. 24D, indicating that the functionalizing agent was successfully grafted to the walls of the silica framework, though not necessarily inside the pores themselves. Quantification of the ²⁹Si MAS spectrum shows that the percentage of fully cross-linked Q⁴ sites is approximately the same as in the pre-functionalized sample (41%). However, now 24% of the remaining silica species are either T² or T³ moieties corresponding to sites in which the functionalized molecule has been grafted. Given the high porosity (˜0.95, ˜970 m²/g) of these mesoporous silica materials, it is unlikely that such a large percentage of the silica is present only on the external surfaces of the powder. These results confirm the efficacy of the general procedure of solvent extraction, washing, drying, and the vapor phase deposition of the n-butyltrichlorosilane functional group onto mesoporous silica to obtain hydrophobic internal surfaces. Though demonstrated for approximately micron-size powders, the same or very similar grafting efficacies are expected for mesoporous films with similar thicknesses and pore dimensions.

With the cubic mesostructured silica pores functionalized to provide hydrophobic interior surfaces, conjugated organic oligomers could then be introduced to incorporate photo-responsive guest species by further post-synthesis modifications. In particular, the use of oligomers, as opposed to much larger molecular-weight polymers, was expected to provide lower resistances to mass-transfer into the mesopores during loading, and thus better and more uniform penetration.

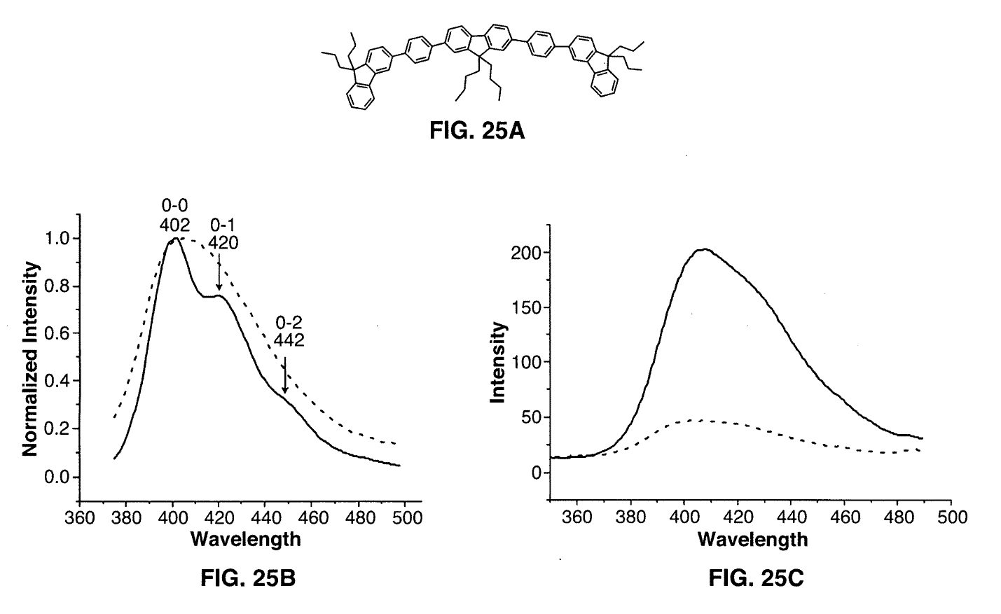

For example, refer to FIG. 25. FIG. 25A illustrates the conjugated octaphenylene oligomers incorporated into the hydrophobically-functionalized cubic mesoporous silica powder. FIG. 25B shows normalized photoluminescence spectra of the conjugated oligomers dissolved in anhydrous toluene 0.025 mg/mL (solid line, at 325 nm) and when incorporated into hydrophobically-functionalized cubic mesoporous silica powder after brief washing for 5 min in toluene (dashed line, at 325 nm). FIG. 25C shows photoluminescence spectra of conjugated oligomers incorporated into hydrophobically-functionalized cubic mesoporous silica powder before washing (solid line, excitation at 275 nm) and after washing (dashed line, excitation at 275 nm) for 5 min in toluene. The functionalized mesoporous silica was stirred in a solution of conjugated octaphenylene oligomers, FIG. 25A, in toluene for 48 h at 50° C. to increase oligomer mobility and decrease solvent viscosity to promote oligomer incorporation into the mesopore channels. The photoluminescence spectrum shown in FIG. 25B (solid line) of the conjugated oligomer dissolved in anhydrous toluene shows bands can be deconvoluted into three peaks, the 0-0 emission band at 402 nm, the 0-1 emission band at 420 nm, and 0-2 emission band at 442 nm. The excitation wavelength for the conjugated oligomer dissolved in anhydrous toluene was increased from the optimal absorption wavelength (275 nm) to 325 nm to prevent the emission from saturating the detector (despite the signal attenuators and small concentrations used). This increase in excitation wavelength resulted in less than a 1 nm red shift of the emission. When the oligomers are incorporated into the hydrophobically-functionalized cubic mesoporous powder, an inhomogeneous broadening of the emission spectrum is observed, as seen in FIG. 25C.

This broadening is consistent with decreased inhomogeneous aggregation of the oligomer species, now confined inside the mesopores, indicated by increased emission from the 0-1 band relative to the 0-0 band, which has been observed previously for semiconducting polymers incorporated into a silica mesoporous host. FIG. 25C shows the non-normalized emission spectra of the same powder before (solid line) and after (dashed line) a brief period (5 min) of washing in toluene to remove oligomers from the external surfaces of the powder particles. The photoluminescence intensity sharply decreases (FIG. 25C), indicating that a substantial amount of the oligomers were removed from washing. After such washing, the normalized spectra in FIG. 25B, shows the relative broadening of the photoluminescence from the incorporated octaphenylene oligomer (dashed line) compared to the oligomer in solution (solid line). As the washing time increases, the signal intensity of the emission spectrum also decreases, indicating that these small molecules interact relatively weakly with the mesopore surfaces and can be easily leached out of the pores. Increasing the rates of solvent removal and block-copolymer self-assembly, and therefore, the rate of silica cross-linking is expected to assist in preventing phase-segregation of the semiconducting polymer species and their incorporation into the silica mesochannels.

### Conclusion

Characterization of co-assembled mesostructured P123-silica nanocomposite systems containing porphyrin dyes or semiconducting polymers indicates that a vertically aligned mesostructure can be formed, while simultaneously incorporating photo-responsive guest molecules with different supramolecular architectures into the patterned films. Solid-state 2D NMR (under ultrafast MAS conditions) and anisotropic optical measurements could be used to establish unambiguously whether the guest molecules can be incorporated and aligned into the mesostructured silica host films as opposed to being isotropically aggregated among different domains or on the external surface of the patterned mesostructured films.

By incorporating a semiconducting polymer into the mesostructured host matrix, mesostructured films can be prepared on conducting ITO substrates. This would allow integration into an electroluminescent device, in which the total emission from electronic excitation of the polymer could be used to assess the degree of connectivity between both electrical contacts. When compared against a standard sample of the same weight loading of the semiconducting polymer in an unaligned mesostructure, co-alignment of the mesostructured host film and semiconducting polymer guest species are expected to yield improved performance of an LED device. Once such an electroluminescent device is formed, polarized electroluminescence measurements can be undertaken to quantify the emission anisotropy from the semiconducting polymer.

### Example

### Mesostructured Titania Films with Controllable Orientational Ordering

Orientationally ordered mesostructured titania with controllable directional alignments can be prepared by using the same strategies as for silica, but with precursor solution compositions and processing conditions adapted for the different chemistries of titania and silica. Titania has a number of interesting optical and electronic properties that are not shared by silica and that make titania suited for diverse applications in solar cells, catalysis, and semiconductor devices. Among the differences between titania and silica in the syntheses of orientationally ordered mesostructured films are that titania precursor species often cross-link more rapidly than silica, making self-assembly difficult. This problem may be managed by using acetylacetone as a chelating agent to slow the rate of titania cross-linking.

To impart interesting opto-electronic, catalytic, or semiconducting properties, guest species, such as conjugated polymers, organic dye molecules, or inorganic nanoparticles can be incorporated into the orientationally ordered mesostructured titania material, which serves as a host matrix. This, however, presents a number of additional challenges, with respect balancing mutual solubilities, processabilities, and other compatibilities of the various components under synthesis and conditions that promote high extents of mesostructural ordering and controllable orientational ordering.

For example, while mesostructured silica and titania can be synthesized in polar solvents (e.g., water and ethanol), finding a suitable solvent system for the inorganic precursor species, the structure-directing agents (SDA) (e.g., non-ionic poly(ethyleneoxide)-poly(polypropyleneoxide)-poly(ethyleneoxide) Pluronic® P123 and F127 triblock copolymers, low-molecular-weight surfactants (e.g., ethyleneoxide-alkyl Brij®-56), and one or more guest species is often challenging. This is especially true for relatively hydrophilic mesostructured titania and highly hydrophobic guest molecules, such as conjugated polymers (e.g., MEH-PPV), for which mutually compatible solvents are few. The solvent tetrahydrofuran (THF) balances many of the compatibility issues and is suitable for the alignment procedures described here. Furthermore, by judicious selection of the composition and processing conditions for the different solvent, inorganic, structure-directing, and guest species, one can exert significant control on how and where the species self-assemble, at what surfaces they nucleate, and how the resulting mesophase domains grow.

### Materials and Methods

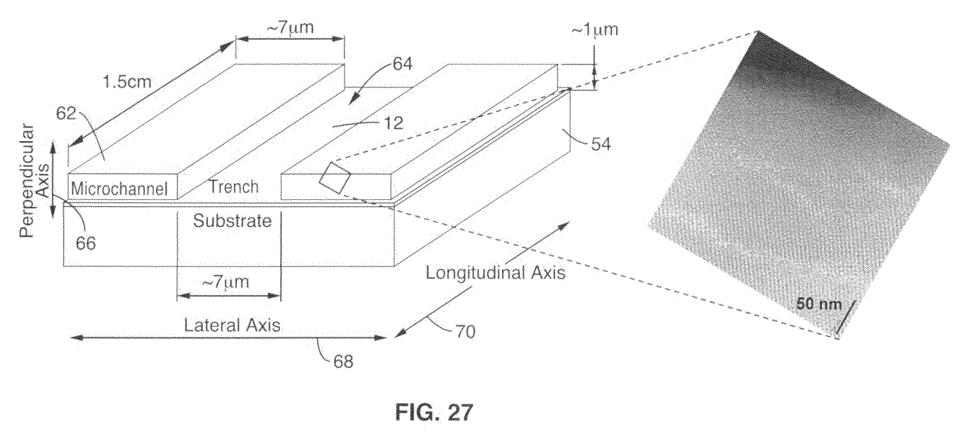

One way to implement this embodiment of the invention is to deposit 11 μL of a precursor solution onto a desired substrate using a pipette. Glass, titania-coated Kapton® (a polymer), or silicon are commonly used as substrates, but many other substrates are suitable for use, including other inorganic substrates or organic substrates (e.g., polymers or organic surface-coatings), based on their adhesion, device application, or other properties. Once the precursor solution has been deposited on the substrate, it is subsequently covered by a stamp or mold that can be patterned arbitrarily, according to device needs and tolerances. For the present applications, a ca. 8-mm thick poly(dimethylsiloxane) (PDMS) stamp/mold was used with micropatterned channels 1 μm deep, 7 μm wide, and several millimeters long (FIG. 27, left).

A suitable titania precursor solution can be prepared by mixing 1 mL tetraethoxy-titanium (TEOT, Ti(OC₂H₅)₄) with 0.35 mL of concentrated aqueous hydrochloric acid. This causes a precipitate to form, which dissolves upon stirring after several minutes. 10 min after the addition of the acid, 0.35 mL acetylacetone (acac) is added, which causes the solution to turn yellow. This titania precursor solution is then added to a solution containing the structure-directing agent (SDA), e.g., low-molecular-weight surfactant species such as Brij®-56, or block-copolymer species such as Pluronic® P123 or F127. For Brij®-56, the SDA precursor solution contains 0.47 g of the Brij®-56 dissolved in 4 mL of THF. For Pluronic® P123, 0.53 g of the P123 is dissolved in 11.47 g of THF.

If functionalization of the titania network is desired, then species, such as trimethoxycyclopentadienyl titanium (TMCPT), can be added before casting or patterning the film. For example, 10 μL of TMCPT can be added to introduce hydrophobic character and/or phenyl groups into the resultant titania network, which can be achieved without disrupting mesostructural ordering of the final material. Finally, if guest molecules are to be incorporated, a guest-molecule precursor solution is mixed with the SDA precursor solution before casting or patterning. For example for the conjugated polymer MEH-PPV, the guest-molecule precursor solution consists of 1.2 to 12 mg of MEH-PPV dissolved in 4 mL of THF. This solution is heated to 55° C. for approximately 1 h and then filtered with 5.0 and 0.45 μm Teflon® filters prior to being combined with the SDA and titania precursor solutions and then used for casting or patterning a film.

Controlling the direction of solvent flux provides way to control the alignment of mesostructured inorganic materials. The same or similar precursor solutions as described above can be used to prepare mesostructured titania films with orientational ordering that can be controlled according to the material composition and processing conditions. Important considerations that influence the formation of aligned mesostructured materials are the rates and direction(s) of solvent removal, the type and anisotropic character of the mesostructure(s) formed, and the interactions between the self-assembling SDA species and the surface(s) from which the solvent species leave the precursor solution (e.g., within the PDMS-patterned microchannels), temperature, etc. By adjusting these, mesostructured titania can be prepared with orientational ordering, for example, as hexagonal phases without or with guest species, such as MEH-PPV, and/or without or with functionalized titania networks, such as TMCPT, and with cylinder alignments predominantly perpendicular to the substrate (i.e., ‘vertically’), with alignments predominantly in the plane of the substrate oriented perpendicular to the long microchannel axes (e.g. ‘laterally’), or with alignments predominantly in the plane of the substrate oriented parallel to the long microchannel axes (e.g. ‘longitudinally’).

Under the conditions used here, the use of Brij®-56 SDA in THF with a 8-mm PDMS stamp/mold (the latter of which is predominantly devoid of dissolved solvent species) tends to form hexagonal mesostructured titania with orientationally ordered cylinders perpendicular (vertical) to the substrate. By comparison, using similar precursor solutions and procedures as described above, but with a thinner PDMS stamp ca. 1 mm thick and covered by a glass or metal plate, most of the solvent species are removed (by diffusion) from the microchannels laterally via the sides of the stamp, rather than being removed in a direction perpendicular to the substrate. This causes the hexagonal mesostructured titania to self-assemble and grow in domains that are aligned in the plane of the substrate, with alignments that can be controlled to be lateral or longitudinal with respect to the microchannel axes, according to the predominant direction(s) of solvent removal.

By using a rectangular stamp and placing solvent selectively, such as along the shorter ends, the direction of solvent removal can be restricted predominantly to a single axis that results in preferential orientational ordering of the resulting mesostructure along that axis. A patterned film (or monolith) can be oriented at an arbitrary angle relative to such an axis or axes, so as to produce a film (or monolith) with laterally, longitudinally, or other uniaxially aligned mesostructural order. More complicated orientational ordering may be achieved by controlling the time-dependent removal of one or more solvent species, optionally in different directions.

Another way to control the orientational ordering of mesostructured titania is by the selection of the structure-directing agent (SDA), according to the relative hydrophobicity-hydrophilicity of its substituent groups, compared to the hydrophobicity or hydrophilicity of the solvent(s) and mold or substrate surfaces at which the mesostructured phases nucleate and grow. For example, for hexagonally mesostructured titania films, vertical alignment of the cylindrical-aggregates normal to the substrate can be achieved in THF and at relatively hydrophobic PDMS surfaces by using a structure-directing agents with more hydrophobic non-polar (e.g., alkyl) chains, such as Brij®-56. By comparison, laterally or longitudinally aligned cylindrical-aggregates of mesostructured titania can be controllably achieved in THF by using structure-directing agents with more polar cores, such as the propyleneoxide chains present in block copolymers like Pluronic® P123.

### Results and Discussion

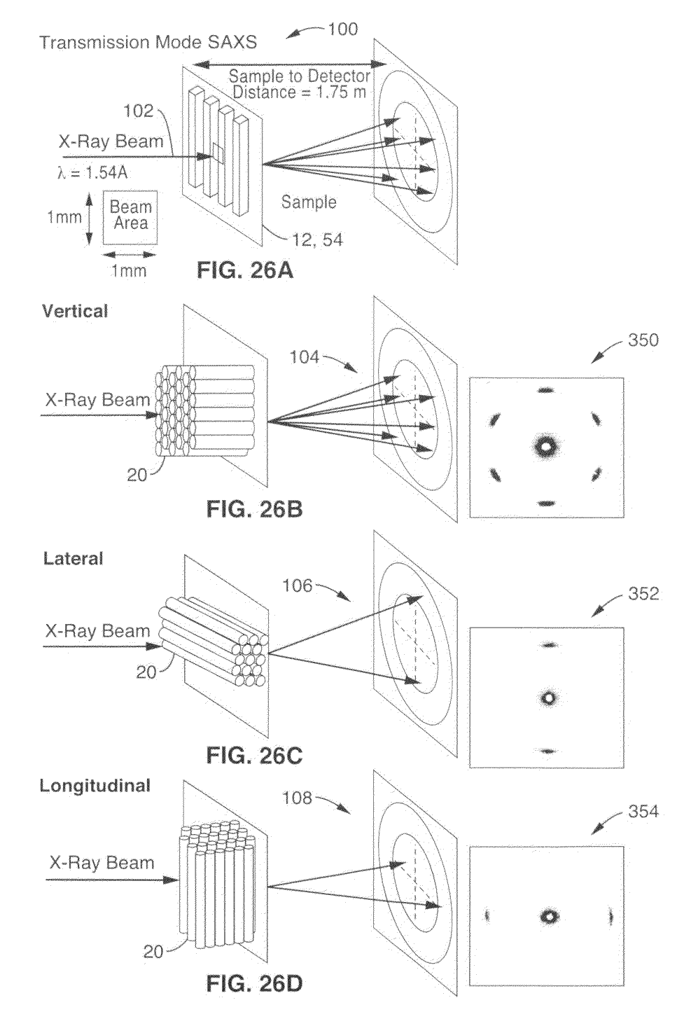

The properties of mesostructured titania films, and specifically their anisotropic orientational ordering, can be characterized by a variety of methods, including Small Angle X-ray Scattering (SAXS) and transmission electron microscopy (TEM). FIG. 26A shows the general configuration for conducting transmission-mode SAXS measurements of patterned mesostructured films, and FIG. 26B-26D shown specific SAXS-sample configurations with respect to three different orientationally ordered hexagonally mesostructured titania-Brij®-56 films, accompanied by validating experimental results for (FIG. 26B) vertically, (FIG. 26C) laterally, and (FIG. 26D) longitudinally aligned mesostructures, respectively.

Two-dimensional (2D) SAXS provides insight into the type and extent of mesostructural ordering of the materials and into the degrees to which they are orientationally ordered with respect to the incident 1-mm² X-ray beam, as illustrated in FIG. 26A. For example, for a vertically aligned hexagonal mesostructured film, SAXS conducted in transmission mode (i.e., perpendicular to and through the film and substrate) produces a characteristic six-spot pattern 350, shown in FIG. 26B, with the narrowness of the spots reflecting the extent of hexagonal mesostructural and orientational order. For laterally or longitudinally aligned hexagonal mesostructured films, transmission-mode SAXS measurements exhibit two-spot patterns 352, 354, shown in FIG. 26C and FIG. 26D, respectively, with the two spots situated along different orthogonal axes in the two cases, according to their respective orientations with relative to the incident X-ray beam. Accompanying each of schematic diagrams depicting the different configurations of the transmission-mode SAXS measurements are experimentally measured 2D SAXS patterns for micropatterned mesostructured titania films. The six-spot and two orthogonal two-spot patterns establish the high extents of vertical, lateral, or longitudinal orientational ordering in the respective mesostructured titania films which were prepared and controlled according to the protocols outlined above.

Transmission electron microscopy (TEM) is a powerful technique that allows direct visualization of the mesostructure over relatively small regions of a sample. TEM images can be obtained for films in cross-section by using a focused-ion-beam (FIB) milling to cut a trench into or through a microchannel, which can then be imaged from the side in the plane of the substrate. An example of a cross-sectional FIB-TEM image acquired from a micropatterned, hexagonal mesostructured titania-Brij®-56 film is shown in FIG. 27.

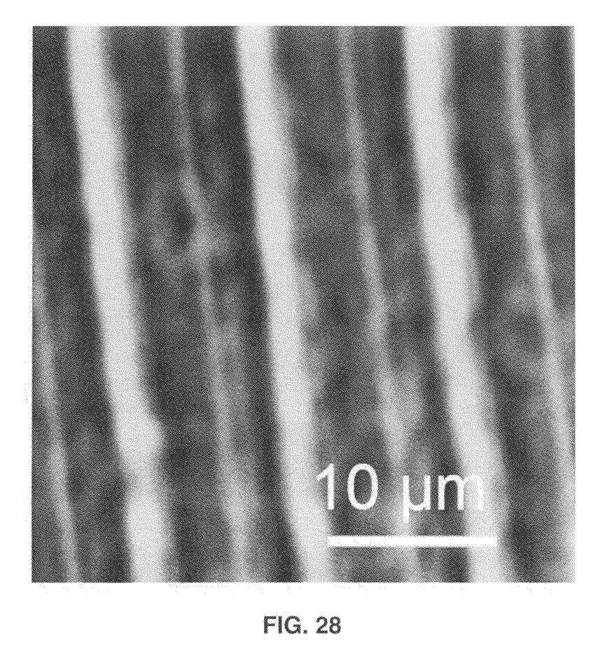

The left portion of FIG. 27 is a schematic diagram of two microchannels on a micropatterned substrate as illustrated previously in FIG. 3, with representative dimensions used in the preparation of the orientationally ordered mesostructured titania. The right portion of FIG. 27 is a focused-ion-beam TEM image of a cross-section of a vertically aligned, hexagonal mesostructured titania-Brij®-56 film showing the high extent of vertical alignment of the cylinders. The top edge of the image is the upper surface of the microchannel; the image was acquired from a region as indicated in red on the schematic diagram. The film corresponds to a sample prepared under similar conditions as used to acquire the SAXS pattern in FIG. 26B and confocal microscope image in FIG. 28.

The image shows a high degree of vertical orientational ordering of the cylinders relative to the free microchannel surface that is representative of other such images acquired at different locations within the same film and other films prepared under similar conditions. These results are complementary to and consistent with the results obtained by SAXS in FIG. 26B, which established high extents of vertically aligned hexagonal mesostructured domains.

The incorporation of photo-responsive guest molecules into mesostructured titania films can be studied by using fluorescence confocal microscopy, in combination with SAXS and TEM. SAXS and TEM measurements establish that the mesostructure ordering and alignment of the material appears to be undisturbed by the introduction of guest molecules. Confocal microscopy is useful to assess whether macroscopic aggregation and phase-separation of guest species may have occurred, by being able to detect aggregates on the scale of 100 nm to 1000 μm in size.

For example, FIG. 28 shows a fluorescence confocal microscope image of a micropatterned, vertically aligned, hexagonal mesostructured titania-Brij®-56 film containing 0.12 wt % MEH-PPV conjugated polymer guest species. Bright stripes are clearly seen, corresponding to fluorescence from MEH-PPV in the mesostructured titania filling the microchannels. The darker striped areas in-between correspond to the trench regions separating the microchannels with less MEH-PPV (as expected), and shown some fluorescence due to imperfect dewetting at the PDMS stamp-substrate surface that allowed some material to remain in the trenches. The uniformity of the fluorescent-light intensity distribution within the stripes in FIG. 28 establishes that the MEH-PPV guest molecules are uniformly distributed within the microchannels. The confocal microscopy measurements establish an upper limit of ca. 100 nm on the sizes of MEH-PPV aggregates (if any might be present) in the film over millimeter regions of the sample. This suggests that the MEH-PPV guest species are incorporated within the ca. 10 nm cylindrical channels of the mesostructured titania, which is separately consistent with complementary TEM results: in none of the TEM images acquired for this or similar films have MEH-PPV aggregates been observed (down to ca. 10 nm), consistent with effective dispersal and solubilization of the MEH-PPV guest species within the mesostructured titania-Brij®-56 film in these samples.

### Conclusion

Mesostructured titania films can be prepared with controllable orientational ordering by judicious selection of precursor solution compositions, the compositions, structures and/or surface properties of patterning stamps/molds, the directions and rates of solvent removal, temperature, surface substrate properties, surrounding atmosphere, pressure, etc. Furthermore, a wide variety of functional guest species can be incorporated during or after film syntheses, such as MEH-PPV or other photo-responsive organic molecules, inorganic species, such as semiconducting, conducting, or catalytic nanoparticles or clusters, organic species, organometallic groups, acidic or other ionic moieties, adsorption- or transport-selective species, or mixtures thereof. These materials and associated methods of preparation are novel and have a number of promising applications, particularly in opto-electronic devices, such as solar cells, as semipermeable membranes, as sensors, or as catalysts. The methods described can be combined with the use of other externally applied fields (e.g., electric, magnetic, light, flow, etc.), which can be furthermore applied transiently to allow more complicated patterning or alignments to be achieved. In addition, the methods described are not limited to films, but can be used for monoliths with different shapes, fibers, or other objects.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. An assembled structure, comprising:
a substrate; and
a mesostructured material supported by the substrate;
said mesostructured material having a perpendicular axis, a longitudinal axis, a lateral axis, or a radial axis, relative to the substrate;
said mesostructured material comprising a plurality of mesochannels orientationally ordered along the same axial direction in relation to a said axis of the substrate.

2. A structure as recited in claim 1, wherein said substrate comprises a metalized or oxide substrate.

3. A structure as recited in claim 1, wherein said substrate comprises titanium or aluminum.

4. A structure as recited in claim 1, wherein said orientational ordering occurs for hexagonal, lamellar, cubic or other phases, including crystalline phases.

5. A structure as recited in claim 1, wherein said mesostructured material exhibits anisotropic properties.

6. A structure as recited in claim 5, wherein said anisotropic properties are selected from the group consisting of anisotropic ion-transport, diffusion, photoluminescent properties, light-emission and light-absorption.

7. A structure as recited in claim 1, wherein said mesostructured material includes an photo-responsive molecule or nanoparticle.

8. A structure as recited in claim 1, wherein said mesostructured material exhibits orientational order>100 nm from a surface and >100 μm in one or more dimensions.

9. A structure as recited in claim 1, wherein said mesostructured material contains organic, inorganic, or a mixture of such species in a covalently bonded network.

10. A structure as recited in claim 1, wherein said structure is in the form of a film.

11. A structure as recited in claim 10, wherein said film comprises a patterned film.

12. A structure as recited in claim 1, wherein said structure is in the form of a monolith.

13. A structure as recited in claim 1, wherein said structure is in the form of a fiber.

14. A structure as recited in claim 10, wherein said mesochannels are hexagonal phase mesochannels that are orientationally ordered predominantly perpendicular to the substrate.

15. A structure as recited in claim 11, wherein said mesochannels are hexagonal phase mesochannels that are orientationally ordered predominantly lateral to the microchannel.

16. A structure as recited in claim 11, wherein said mesochannels are hexagonal phase mesochannels that are orientationally ordered predominantly longitudinal to the microchannel.

17. A structure as recited in claim 1, wherein said mesostructure contains guest species that are also orientationally ordered.

18. A structure as recited in claim 9, wherein said covalently bonded network contains species that aid the incorporation and/or influence the location or interactions of guest species within said mesostructure.

19. An assembled structure, comprising:
a substrate;
a microchannel formed on the substrate;
said microchannel having a perpendicular axis, a longitudinal axis, and a lateral axis; and
said microchannel comprising a mesostructure;
said mesostructure comprising a plurality of mesochannels orientationally ordered along the same axial direction in relation to a said axis of the microchannel.

20. An assembled structure, comprising:
a planar metalized substrate;
a planar silica microchannel formed on the substrate;
said microchannel having a perpendicular axis, a longitudinal axis, and a lateral axis; and
said microchannel comprising a mesostructure;
said mesostructure comprising a plurality of mesochannels orientationally ordered along the same axial direction in relation to a said axis of the microchannel;
wherein said mesostructure exhibits anisotropic properties.

21-39. (canceled)
